(19) United States
(12) Patent Application Publication
(10) Pub. No.: US 2026/0288690 A1
(43) Pub. Date: Sep. 24, 2026

(54) SYSTEM

(71) Applicant: SoftBank Group Corp., Tokyo (JP)

(72) Inventor: Eisaku FUJIMOTO, Tokyo (JP)

(73) Assignee: SoftBank Group Corp., Tokyo (JP)

(21) Appl. No.: 19/567,045

(22) Filed: Mar. 14, 2026

(30) Foreign Application Priority Data
Mar. 19, 2025 (JP) 2025-045132

(51) Int. Cl. G06F 16/22; G06F 16/215; G06F 16/28; G06F 40/205; G06F 40/30; G06F 40/40

(52) U.S. Cl. CPC G06F 16/2246; G06F 16/215; G06F 16/285; G06F 40/205; G06F 40/30; G06F 40/40

(57) ABSTRACT

A system includes a processor that is configured to analyze, by using a generative AI model, image data and document data transmitted by email, and automatically store the analyzed image data and document data in a specific information storage device, organize data stored in the information storage device by applying a classification algorithm implemented by a generative AI model to the data, and generate, by using a generative AI model, notification content when sending a notification to a stakeholder, and transmit the notification content via a communication means.

### CROSS-REFERENCE TO RELATED APPLICATION

This application is based on and claims priority under 35 USC 119 from Japanese Patent Application No. 2025-045132 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional systems for managing email attachments and related digital documents require significant manual operations by users, including downloading files from email, naming and categorizing the files, storing the files in appropriate folders or repositories, and notifying relevant stakeholders. Such operations are time-consuming, prone to human error, and difficult to scale as the volume of email and data increases. In addition, conventional notification mechanisms generally use fixed, rule-based templates that do not adapt to context, user preferences, or emotional state, resulting in information overload or missing urgent information. Furthermore, existing systems often lack an integrated mechanism to monitor and optimize the overall data set in a storage device, which leads to redundant data, inefficient use of storage resources, and difficulty in retrieving relevant information. Therefore, there is a need for a system that can automatically analyze email-transmitted data by using a generative AI model, store and organize such data in an information storage device, generate adaptive notification content, and, when necessary, optimize the stored data, while also taking into account user emotion to adjust data organization and notification priority.

### SUMMARY

To solve the above-described problems, the present invention provides a system comprising a processor, wherein the processor is configured to analyze, by using a generative AI model, image data and document data transmitted by email, and automatically store the analyzed image data and document data in a specific information storage device. The processor is further configured to organize data stored in the information storage device by applying a classification algorithm implemented by a generative AI model to the data, and to generate, by using a generative AI model, notification content when sending a notification to a stakeholder, and transmit the notification content via a communication means. In addition, the processor is configured to use an emotion analysis engine to recognize an emotion of a user, and to adjust, according to the recognized emotion, at least one of an organization of the data and a priority of the notification by using a generative AI model. Furthermore, the processor is configured to monitor overall data in the information storage device as needed, and to perform optimization by applying, by using a generative AI model, an optimization algorithm to the overall data, thereby reducing redundancy, improving storage efficiency, and enhancing retrieval and delivery of relevant information.

The term “system” refers to an integrated combination of hardware and software components including at least one processor and associated memory, communication interfaces, and storage resources, which are configured to execute the functions described in the claims.

The term “processor” refers to one or more hardware processing units, such as a central processing unit (CPU), a graphics processing unit (GPU), a digital signal processor (DSP), or any combination thereof, capable of executing instructions to perform the operations described in the claims.

The term “generative AI model” refers to a machine-learned model, such as a neural network or large language model, that is trained to generate or transform data, including but not limited to text, labels, summaries, classifications, or other content, based on input data.

The term “image data” refers to digital data representing visual information, including but not limited to photographs, scanned images, graphics, diagrams, and screenshots, in any suitable file format such as JPEG, PNG, GIF, or TIFF.

The term “document data” refers to digital data representing textual or structured documents, including but not limited to word processing files, spreadsheets, presentations, PDFs, and other electronic documents.

The term “email” refers to an electronic message transmitted over a network using an electronic mail protocol, such as SMTP, POP, or IMAP, and including at least a header, a body, and optionally one or more attachments.

The term “information storage device” refers to any physical or virtual storage resource, including local storage, network-attached storage, cloud storage, databases, or file servers, that is configured to store and manage data as described in the claims.

The term “automatically store” refers to storing data in the information storage device by processing performed by the system without requiring explicit, manual operations for each storage event by a user.

The term “organize data” refers to processing data stored in the information storage device so as to structure, group, classify, label, or otherwise arrange the data to facilitate management, retrieval, or usage of the data.

The term “classification algorithm” refers to a computational procedure that assigns one or more categories, labels, or classes to input data based on learned parameters, rules, or patterns, and that may be implemented using a generative AI model.

The term “notification” refers to a message or alert generated by the system for a stakeholder, indicating the occurrence of an event related to the data, such as storage, update, organization, or optimization of the data.

The term “notification content” refers to the textual, graphical, or structured information included in a notification, such as summaries, titles, explanations, priorities, links, or metadata, which is generated by the generative AI model.

The term “stakeholder” refers to any user, group of users, or external system that is designated to receive notifications or otherwise interact with the data managed by the system.

The term “communication means” refers to any hardware, software, or network interface, including email servers, messaging platforms, chat tools, APIs, or other communication channels, that enables the transmission of notifications from the system to stakeholders.

The term “emotion analysis engine” refers to a hardware and/or software module configured to analyze input data related to a user, such as text, voice, or behavioral signals, and to estimate an emotional state or sentiment of the user.

The term “emotion of a user” refers to an estimated affective or sentiment state of the user, such as positive, negative, neutral, or more granular emotional categories, as determined by the emotion analysis engine.

The term “priority of the notification” refers to a level or rank assigned to a notification, such as high, medium, or low, which determines the order, timing, prominence, or delivery method of the notification to the stakeholder.

The term “monitor overall data” refers to periodically or conditionally inspecting, scanning, or analyzing data stored in the information storage device, including its volume, redundancy, access history, or other characteristics.

The term “optimization algorithm” refers to a computational procedure that adjusts, reorders, removes, compresses, deduplicates, or otherwise processes data in order to improve storage efficiency, retrieval performance, or system responsiveness.

The term “as needed” refers to execution of processing operations, such as monitoring or optimization, in response to predefined conditions, schedules, thresholds, or triggers, without requiring a manual command for each execution.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

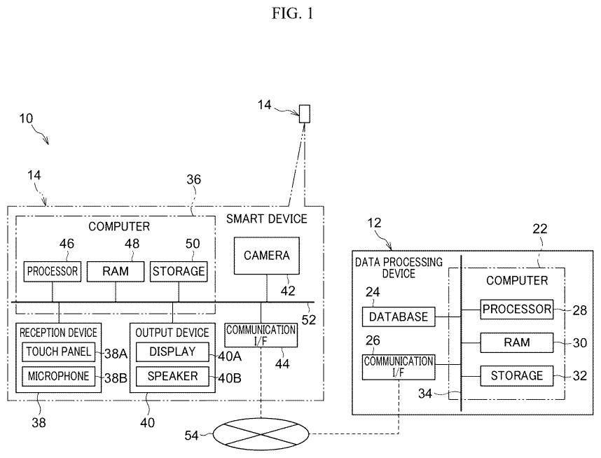

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

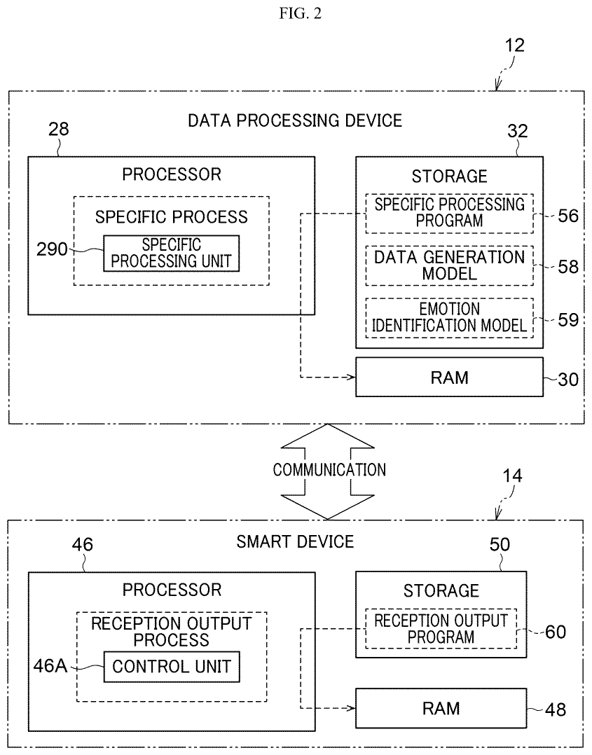

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In modern communication environments, a very large volume of electronic communication information such as electronic mail and message data is continuously generated, and a significant portion of such information contains attached visual information or document information. Conventionally, storage systems and content management systems have required human operators to manually download, rename, classify, and store such attachments into appropriate storage locations, and to manually compose and send notifications to relevant parties. This manual workflow is time-consuming, error-prone, and difficult to scale as the volume and diversity of data increase.

Traditional automated solutions typically apply fixed, rule-based processing logic, such as simple pattern matching on mail subjects or folder rules on a mail server. These conventional approaches exhibit several technical limitations. First, they lack the ability to robustly interpret unstructured or semi-structured content in electronic communications, resulting in misclassification or inconsistent naming conventions for stored files. Second, they often require predefined and rigid folder structures and rule sets that are cumbersome to maintain and that do not adapt to evolving usage patterns, topics, or document types. Third, they provide limited support for generating context-rich, human-readable notification messages, often sending generic or incomplete notifications that reduce the usefulness of automated alerts. As a result, system users must still expend significant effort to locate relevant documents, understand their context, and manage access and sharing.

Furthermore, existing systems typically treat the configuration and evolution of backend processing logic as a manual software development task. In particular, when requirements change, engineers must revise and redeploy code that governs email parsing, attachment validation, naming standards, classification rules, and notification formats. This approach imposes technical overhead on the computing environment, including increased development and deployment cycles, higher risk of inconsistent configurations across servers, and limited adaptability to new communication patterns or document types. The underlying computing infrastructure therefore remains static and inflexible, and the potential of modern machine learning systems, such as generative AI models, is not fully leveraged to dynamically configure and optimize content processing pipelines.

In addition, while some systems employ machine learning to classify data, they often do not tightly integrate such models with the communication protocols, storage service APIs, and notification mechanisms in an end-to-end manner. Specifically, conventional architectures do not systematically utilize generative AI models both to derive classification information and to produce structured metadata and notification content that are directly compatible with storage service attribute formats and user-facing interfaces. This leads to fragmented processing flows, redundant data transformations, and inefficient use of computing resources.

There is therefore a need for a technical solution that improves computer-implemented processing of electronic communication information and associated attachments by: (i) integrating generative AI models into the core processing pipeline for name normalization, classification, and notification content generation; (ii) enabling dynamic optimization of processing policies based on monitored content; and (iii) programmatically generating or adapting control programs themselves by means of generative AI models. Such a solution should reduce manual intervention, enhance the accuracy and consistency of stored metadata, improve the quality and relevance of notifications, and provide a more flexible and adaptive computing architecture for managing attached content at scale.

The specific processing by the specific processing unit 290 of the data processing device 12 in Example 1 is realized by the following means.

The present invention provides a server comprising a communication apparatus configured to connect to an information processing apparatus via an electronic communication protocol and to acquire unprocessed electronic communication information, a storage apparatus configured to cooperate with an electronic information storage service, and a processor configured to cause the server to: analyze structured information of the acquired electronic communication information; extract attached information represented as visual information or document information from the electronic communication information; validate the attached information based on type information and size information and select attached information that satisfies predetermined conditions; store the selected attached information, via a communication procedure provided by the electronic information storage service, in a storage region of the electronic information storage service and acquire identification information associated with the attached information; generate name information of the attached information by normalizing the name information based on subject information and time information included in the electronic communication information; provide at least a part of the electronic communication information or at least a part of the attached information as input information to a generative AI model and cause a generation processing unit included in the generative AI model to generate classification information relating to the attached information; set the name information and the classification information as attribute information of the electronic information storage service with respect to the attached information; provide input information including the name information, the classification information, and the identification information to the generation processing unit and cause the generation processing unit to generate notification information; and transmit the notification information to a terminal via the communication apparatus so that the terminal displays the name information, the classification information, and the identification information on a display apparatus. This enables an improvement in computer technology by providing an end-to-end automated content processing pipeline in which the server system programmatically integrates a generative AI model to normalize file names, generate classification metadata, and compose context-aware notification messages, thereby reducing manual operations, increasing accuracy and consistency of metadata stored in the electronic information storage service, and enhancing the efficiency and adaptability of the underlying computing infrastructure for handling large volumes of electronic communication information and associated attachments.

The term “server” refers to an information processing apparatus including at least one processor and a memory, which executes programs to perform communication control, data analysis, data storage control, and cooperation with external services.

The term “processor” refers to a hardware or logical computation unit, such as a central processing unit or a processing core, that executes instructions to implement functions described in the claims, including control of communication, analysis, generation, and storage operations.

The term “terminal” refers to an information processing apparatus operated by a user, such as a personal computer, a mobile device, or another client device, which receives notification information from the server and presents the information to the user.

The term “storage apparatus” refers to a physical or logical data retention component, such as a semiconductor memory, a magnetic storage device, or a storage subsystem, that stores programs, configuration data, electronic communication information, attached information, or control data used by the server.

The term “communication apparatus” refers to a hardware or software communication interface, such as a network interface controller, a communication module, or a communication stack, configured to send and receive electronic data over a communication network using a communication protocol.

The term “display apparatus” refers to a device configured to visually present information, such as a display panel, a monitor, or a graphical user interface component that displays notification information, name information, classification information, and identification information.

The term “information processing apparatus” refers to a device or system, such as a mail server or a message server, that stores or manages electronic communication information and that can be accessed by the server via an electronic communication protocol.

The term “electronic communication protocol” refers to a communication rule set used for transmitting and receiving electronic communication information, such as a mail access protocol or a message retrieval protocol.

The term “electronic communication information” refers to information transmitted or received in digital form by means of electronic communication, including mail messages, message bodies, headers, and associated structured or unstructured data.

The term “structured information” refers to information that has a definable structure or format, such as headers, fields, or markup, which can be parsed to identify components including subject information, time information, sender information, or message identifiers.

The term “attached information” refers to information that is included in or associated with electronic communication information and that is separate from the main text content, such as files, binary objects, or embedded resources.

The term “visual information” refers to information that can be recognized visually, such as image data, graphic data, or video data, which may be represented in various digital formats.

The term “document information” refers to information represented as a structured or unstructured text file, a formatted document, or an electronic file containing textual or mixed content.

The term “type information” refers to attribute information indicating a data kind of attached information, such as a media type, a file format, or a content category used to interpret or process the attached information.

The term “size information” refers to information indicating at least one of a data length, a file size, or a capacity of attached information, which can be used to validate or filter the attached information.

The term “predetermined conditions” refers to one or more conditions defined in advance, such as allowed file types, permitted size ranges, or security constraints, used to determine whether attached information is to be selected or rejected.

The term “electronic information storage service” refers to a remote or distributed storage service accessible via a network, which provides a storage region for electronic data and offers a programmatic interface for storing, retrieving, and managing the electronic data.

The term “storage region” refers to a logical or physical area allocated by the electronic information storage service for storing electronic data, such as a folder, a container, or a logical volume.

The term “identification information” refers to information that uniquely or distinctively identifies stored data in the electronic information storage service, such as an identifier, a resource locator, or a reference string.

The term “subject information” refers to information indicating a subject, title, or topic of electronic communication information, such as a subject header of a mail message.

The term “time information” refers to information indicating a time or date related to electronic communication information, such as a transmission time, a reception time, or a creation time.

The term “name information” refers to information used as a name, label, or designation for attached information, such as a file name or a normalized identifier generated based on subject information and time information.

The term “normalizing” refers to processing that converts information into a standardized or consistent format according to predetermined rules, such as adjusting character sets, removing prohibited characters, or applying a naming pattern.

The term “classification information” refers to information used to categorize or classify attached information into one or more categories, classes, or tags, based on content, context, or other attributes.

The term “attribute information” refers to metadata or descriptive information associated with stored data in the electronic information storage service, including name information, classification information, and other properties.

The term “notification information” refers to information generated to inform a user or a system about an event, such as completion of storage, availability of attached information, or updated metadata, and includes at least part of the name information, classification information, and identification information.

The term “generative AI model” refers to a machine learning model configured to generate data, such as text, tags, or other structured information, based on input information, using learned parameters derived from training data.

The term “generation processing unit” refers to a functional component of a generative AI model that processes input information and outputs generated information such as classification information, notification information, or program code.

The term “prompt sentence” refers to input text or data that specifies a generation request to a generative AI model, including a description of desired functionality, processing steps, or program behavior.

The term “processing policy information” refers to information defining rules, preferences, or strategies for processing electronic communication information or attached information, including generation rules for name information, generation rules for classification information, and conditions for transmitting notification information.

The term “generation rule” refers to a rule or set of rules that defines how specific information, such as name information or classification information, is to be produced from input data.

The term “transmission condition” refers to a condition or set of conditions under which notification information is to be transmitted, such as a threshold, a priority level, or an event trigger.

The term “control program” refers to a program or a set of instructions that, when executed by the processor of the server, causes the server to perform processing corresponding to one or more functions defined in the claims, including acquisition, analysis, generation, storage, and notification.

In one embodiment, a server executes a control program stored in a storage apparatus to implement the claimed system. The server includes at least one processor, a memory, a communication apparatus, and an interface for cooperating with an electronic information storage service. The terminal includes at least one processor, a memory, a communication apparatus, and a display apparatus. The server and the terminal are connected via a communication network such as a packet-switched network.

The server uses general-purpose hardware such as a multi-core central processing unit, a volatile memory, and a non-volatile storage device. The server runs a server-class operating system such as a UNIX-based system and uses software modules including a mail access library implementing an electronic communication protocol, a network client library for accessing the electronic information storage service, and a machine learning inference library for executing a generative AI model. The storage apparatus may include a local storage device and a remote storage component provided by the electronic information storage service. The terminal may be a personal computer, a tablet device, or a smartphone executing a web browser or a native application that communicates with the server via the communication apparatus.

The server generates a control program by using a generative AI model in response to a prompt sentence. The server or the terminal prepares a prompt sentence that specifies program generation request information, and the server transmits the prompt sentence to a generative AI model. The generative AI model is implemented as a parameterized neural network, for example a transformer-based sequence model, that has been trained on a corpus of software source code and protocol specifications. The generative AI model includes a generation processing unit that receives the prompt sentence as a sequence of tokens and outputs a sequence of program tokens specifying control logic for the server. The server receives the generated control program, stores the control program in the storage apparatus, and causes the processor to execute the control program to implement the functions described in the claims.

The server uses the control program to access an information processing apparatus implementing an electronic mail service or a message service. The server uses the communication apparatus to establish a secure connection according to an electronic communication protocol, such as a mail access protocol, and obtains electronic communication information including message headers, message bodies, and attached information. The server parses the structured information in the electronic communication information, including subject information, time information, sender information, and identifiers, using parsing modules implemented in software libraries. The server extracts attached information represented as visual information or document information from multipart message structures and stores the extracted attached information in data structures in memory. Each data structure includes fields such as identification information, type information, size information, and pointers to binary data.

The server uses these data structures to perform validation processing. The server compares the type information and the size information of each piece of attached information against predetermined conditions stored in the storage apparatus as configuration data. The predetermined conditions include allowed media types, permitted size ranges, and security rules. The server uses a deterministic rule engine to reject attached information that does not satisfy the predetermined conditions, thereby reducing the risk of invalid or non-compliant data being transmitted to the electronic information storage service. By using explicit validation rules and by maintaining type and size metadata in structured data fields, the server improves robustness and reduces error rates compared to manual inspection.

The server uses a network client module to access the electronic information storage service via the communication apparatus. The server authenticates with the electronic information storage service and transmits the selected attached information as binary data objects to a storage region in the electronic information storage service. The server receives from the electronic information storage service identification information assigned to each stored object, such as a unique object identifier or a resource locator. The server associates the identification information with the corresponding attached information in a metadata record stored in the storage apparatus. This metadata record includes fields for subject information, time information, name information, classification information, and identification information.

The server generates name information by normalizing a candidate name derived from the subject information and the time information. The server converts the subject information into a normalized text string by removing characters that are invalid in file names, by converting character encodings, and by applying normalization rules such as replacement of whitespace characters and punctuation. The server converts the time information into a formatted time string based on a predetermined time representation. The server concatenates the normalized subject information and the formatted time string, appending a file type extension based on the type information of the attached information. Because the server performs these normalization operations programmatically and applies them to structured metadata, the server produces consistent name information across a large volume of messages, which improves searchability and storage management within the electronic information storage service.

The server uses a generative AI model to generate classification information relating to the attached information. The server constructs an input sequence that includes a representation of the subject information, a partial representation of the message body, and encoded indicators of the type information and size information. The server encodes these elements into a token sequence and provides the sequence to the generation processing unit of the generative AI model. In one embodiment, the generative AI model is a multi-layer transformer network having an encoder-decoder architecture with self-attention mechanisms.

The model parameters are trained in advance using supervised learning on a training dataset of message subjects, message bodies, and human-assigned classification labels.

The server uses a training procedure in which a loss function, such as cross-entropy loss, is computed between predicted token sequences representing labels and ground-truth label sequences. The server, or an external training system, updates model parameters using gradient-based optimization such as stochastic gradient descent with momentum or adaptive learning rate methods. During training, the system uses data augmentation techniques, such as synonym replacement and word order perturbation, to improve robustness. The trained generative AI model thus learns non-linear relationships between text features and category labels, enabling the server to generate classification information that reflects semantic content rather than relying solely on fixed keyword rules.

When the server uses the generative AI model during operation, the server applies a beam search or top-k sampling algorithm to the output probability distribution over label tokens to obtain candidate classification labels. The server filters the candidate labels based on length constraints, allowed character sets, and similarity measures to existing labels. The server then maps the candidate labels to classification information suitable for use as attribute information in the electronic information storage service. Because the generative AI model produces classification information from a high-dimensional feature space, including contextual cues from the message body and meta-features such as type information and size information, the system achieves higher classification precision and recall compared to simple keyword-based rules. This improvement in classification accuracy leads to enhanced retrieval performance and reduces misplacement of documents in storage.

The server sets the name information and the classification information as attribute information associated with the corresponding stored data object in the electronic information storage service. The server transmits metadata update requests to the electronic information storage service through the communication apparatus, specifying the identification information of the object, the name information, and the classification information. The storage service stores these attributes in an internal metadata structure. Because the server uses a normalized naming scheme and AI-generated classification information, the storage service can index and sort objects more efficiently, thereby improving query response times and reducing storage fragmentation at large scale.

The server generates notification information by again using the generative AI model. The server prepares input information that includes the name information, classification information, identification information, and abbreviated content of the electronic communication information. The server provides the input information to the generation processing unit of the generative AI model, which is configured as a text generation network.

The model receives the input token sequence and outputs a token sequence representing a notification message that explains to a user the nature of the stored object and provides a reference to the stored object via the identification information. The server decodes the token sequence and constructs notification information in a standardized message format. The server transmits the notification information to the terminal via the communication apparatus using a communication protocol such as a mail transmission protocol or an application-layer messaging protocol.

The terminal receives the notification information and stores it in a local memory. The terminal parses the notification information and presents on the display apparatus the name information, classification information, and identification information, optionally in combination with user interface elements for selecting and opening the stored object. The user interacts with the terminal to access the stored object through the electronic information storage service, to confirm that the object has been correctly classified, and to review the context contained in the notification message. Because the notification information is generated by the generative AI model with full access to structured metadata, the terminal can present concise yet contextually rich messages that improve user understanding and reduce the time required to locate and access relevant documents.

The server also performs dynamic optimization of processing policy information. The server collects content information from electronic communication information and attached information that have been processed and stores aggregated statistics such as classification frequencies, error counts, and user correction logs. The server constructs monitoring target data structures representing these statistics and provides the monitoring target data structures as input to the generation processing unit of the generative AI model. The generative AI model outputs processing policy information specifying, for example, threshold values for classification confidence, mapping rules between labels and storage regions, and conditions for sending notifications. The server applies the processing policy information to adjust generation rules for name information, generation rules for classification information, and transmission conditions for notification information. As a result, the server adapts its behavior according to observed usage patterns and feedback, improving processing speed by reducing unnecessary notifications and improving accuracy by focusing classification efforts on ambiguous cases.

The server uses non-conventional processing flows within the control program. For example, rather than applying a fixed rule sequence for message filtering, the server uses a combination of rule-based filtering and generative model-based classification, where the output of each stage is fed into the next stage as structured metadata. The server utilizes specialized data structures such as multi-field records that include probabilistic confidence scores, model version identifiers, and past classification outcomes. The server uses these fields to select which messages to route to the generative AI model, which to process using deterministic rules only, and which to flag for human review. This routing logic is not a mere automation of human sorting but a machine-specific optimization that minimizes computational resources while maintaining classification precision. By reducing the number of calls to the generative AI model for trivial cases and focusing model computation on complex or ambiguous content, the server decreases average processing time and reduces energy consumption.

The server uses a training pipeline that explicitly optimizes for the performance of the end-to-end content management system. The server, or a training environment associated with the server, constructs a training dataset in which input samples are derived from actual processed messages, and target outputs include not only category labels but also system metrics such as retrieval time and error rate. The server defines a composite loss function that combines classification loss with auxiliary loss terms relating to search latency or user-correction frequency. By training the generative AI model with this composite loss, the system learns representations that are aligned with the technical performance of the storage system, thereby improving overall data management efficiency beyond what is achievable by manual rule tuning.

The user may use the system to generate or refine the control program itself. The user, via the terminal, inputs a prompt sentence to the generative AI model. One example of such a prompt sentence is:

“Generate a program for a server that connects to an electronic mail system, extracts attachments from newly received electronic communication information, validates the attachments by type and size, uploads them to a remote storage service, normalizes file names based on message subject and time, generates classification tags using a generative AI model, and creates notification messages including storage identifiers, to be displayed on a client terminal.”

Another example of a prompt sentence is:

“Generate a control program that runs on a server, periodically accesses an electronic communication server, parses structured headers and MIME parts from messages, selects visual and document content as attached information, calls a transformer-based generative AI model to generate classification labels and human-readable notification text, updates metadata attributes in a cloud storage service, and sends optimized notification information to user terminals.”

The server sends such prompt sentences to the generative AI model and receives program text that implements the required functions. The server stores and executes the resulting control program, after appropriate verification. Because this approach uses a generative AI model to synthesize code that precisely reflects the current configuration and processing policies of the system, the server can be updated more quickly and consistently than by manual coding, and the resulting programs are structurally aligned with the dataflow and metadata requirements of the system. This reduces configuration drift and improves maintainability, which are technical improvements in the operation of the computing system.

The system provides technical effects that go beyond mere automation of human procedures.

The server uses internal data structures explicitly designed to support AI-assisted naming, classification, and notification. The server uses a multi-stage processing pipeline that incorporates normalization and AI-generated metadata in a way that improves indexing and retrieval performance in the electronic information storage service. The server uses a generative AI model with specific architectural and training characteristics to achieve classification and notification generation that are optimized for system performance metrics.

The server dynamically adjusts its own processing policies based on AI-generated policy information to reduce computational load while maintaining or improving accuracy. These features collectively enhance processing speed, classification precision, data management efficiency, and resource utilization within the computing environment, and thus improve computer technology itself rather than merely implementing a business workflow.

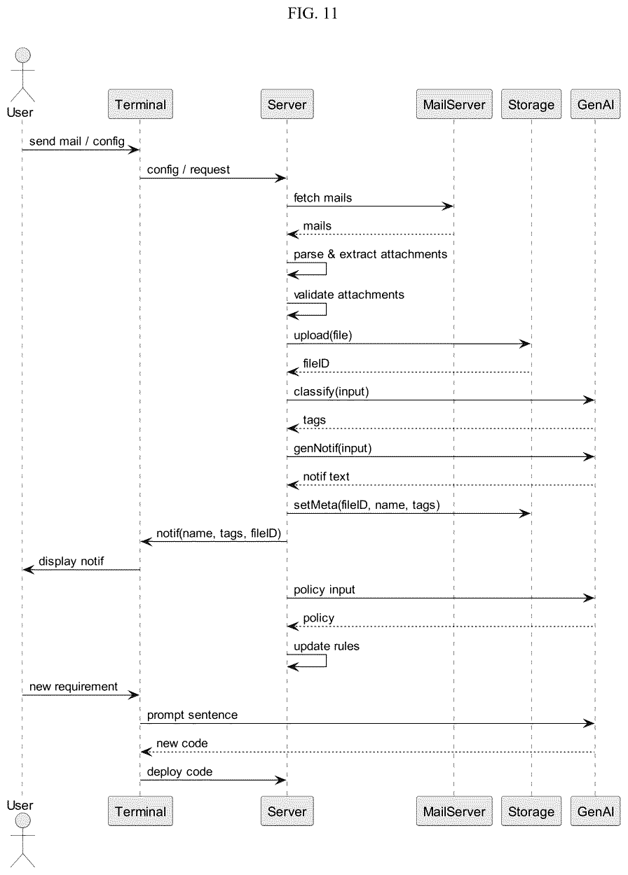

The following describes the processing flow using FIG. 11.

### Step 1:

The server loads configuration information and initializes modules.

The server receives, as input, configuration data stored in a storage apparatus, including communication parameters for an information processing apparatus, authentication information for an electronic information storage service, parameters for a generative AI model, and rules for validation and notification. The server parses the configuration data and stores parameter values in internal data structures in memory. The server initializes software modules such as a mail access library, a network client for the storage service, and a machine learning inference library for the generative AI model. The server outputs initialized module instances and an in-memory configuration object that will be referenced in subsequent processing.

### Step 2:

The server acquires electronic communication information from an information processing apparatus.

The server receives, as input, the in-memory configuration object that specifies an electronic communication protocol, a server address, and authentication credentials. The server uses the communication apparatus to establish a connection to the information processing apparatus and authenticates according to the specified protocol. The server issues protocol commands to retrieve unprocessed electronic communication information, such as message headers and message bodies, identified by message identifiers not yet recorded as processed. The server converts the raw protocol responses into structured message objects and outputs a list of electronic communication information, each element including subject information, time information, sender information, message body data, and encoded attached information.

### Step 3:

The server parses structured information and extracts attached information.

The server receives, as input, the list of electronic communication information from Step 2.

The server uses a parsing module to analyze structured information, including header fields and multipart boundaries, and to identify segments representing attached information. The server decodes the attached information from encoded formats into binary data, and constructs internal records for each attachment containing type information, size information, original name information, and a link to the parent message. The server outputs an attachment list, where each entry is a data structure including binary content, metadata fields, and a reference to the source electronic communication information.

### Step 4:

The server validates attached information based on predetermined conditions.

The server receives, as input, the attachment list from Step 3 and the validation rules from the configuration object. The server compares the type information and size information of each attachment against allowed types and permissible size ranges specified by the rules. The server performs data operations such as type matching, range checking, and flag setting. For attachments that satisfy all predetermined conditions, the server marks them as valid; for others, the server records rejection reasons in metadata fields. The server outputs a filtered attachment list that includes only valid attachments and an auxiliary log of rejected attachments with associated reasons.

### Step 5:

The server uploads valid attached information to an electronic information storage service.

The server receives, as input, the filtered attachment list from Step 4 and authentication parameters for the electronic information storage service. The server uses the communication apparatus and a network client module to establish a session with the storage service. For each valid attachment, the server transmits the binary content along with minimal metadata, such as a temporary name and target storage region. The storage service returns identification information, such as unique object identifiers. The server associates each identifier with the corresponding attachment record by updating the metadata fields. The server outputs a stored attachment list in which each entry includes binary data (or a reference thereto), type and size information, and identification information assigned by the storage service.

### Step 6:

The server generates normalized name information using subject information and time information.

The server receives, as input, the stored attachment list from Step 5 and the electronic communication information linked to each attachment. The server reads the subject information and time information from the parent message and applies normalization rules stored in the configuration object. The server performs string operations such as character filtering, case normalization, replacement of prohibited characters, and formatting of the time information into a standard representation. The server concatenates the normalized subject information and the formatted time information and appends an extension derived from the type information to form normalized name information. The server updates each attachment record with the generated name information and outputs an updated attachment list containing normalized name information for each stored attachment.

### Step 7:

The server generates classification information by using a generative AI model.

The server receives, as input, the updated attachment list from Step 6, the corresponding electronic communication information, and model parameters for the generative AI model.

The server constructs, for each attachment, an input sequence that includes tokens representing subject information, a truncated segment of the message body, type information, and size information. The server encodes these features using a tokenizer and numerical embedding layer and supplies the encoded sequence to a neural network configured as a transformer-based generative AI model. The model computes attention weights and propagates activations through multiple layers to produce probability distributions over possible label tokens. The server applies decoding logic, such as beam search or top-k sampling, to select label token sequences and then converts these sequences into human-readable labels. The server filters and consolidates the labels into classification information suitable as tags or categories. The server writes the classification information into metadata fields of each attachment record and outputs an enriched attachment list that includes both normalized name information and classification information.

### Step 8:

The server updates attribute information in the electronic information storage service.

The server receives, as input, the enriched attachment list from Step 7 and connection parameters for the electronic information storage service. The server, for each attachment record, constructs a metadata update request containing identification information, normalized name information, and classification information. The server transmits these requests via the communication apparatus to the storage service. The storage service stores the received attribute information in its internal metadata structures associated with the corresponding stored objects. The server receives acknowledgment from the storage service and updates the local metadata records to reflect successful attribute setting. The server outputs a confirmed attachment list that includes, for each stored object, the final name information, classification information, and identification information.

### Step 9:

The server generates notification information using the generative AI model.

The server receives, as input, the confirmed attachment list from Step 8 and a notification policy from the configuration object. The server constructs, for each stored object, an input text that includes the final name information, the classification information, the identification information, and a compact description derived from the parent electronic communication information. The server tokenizes the input text and passes the token sequence to the generation processing unit of the generative AI model configured for text generation. The model computes output token probabilities and generates a notification message that describes the stored object and references the identification information. The server decodes the output tokens into a notification text and encapsulates the text in a notification information structure that also includes addressing data for one or more terminals. The server outputs a notification list, each element containing notification information ready for transmission.

### Step 10:

The server transmits notification information to terminals.

The server receives, as input, the notification list from Step 9 and communication endpoint information for the terminals. The server uses the communication apparatus and one or more application-layer protocols to send each notification information element to its target terminal. The server records transmission results, including success or failure codes and timestamps, in a log data structure. The server outputs a transmission report containing, for each notification, the associated stored object identification information, target terminal information, and transmission status.

### Step 11:

The terminal receives and presents notification information.

The terminal receives, as input, notification information transmitted by the server in Step 10.

The terminal parses the notification data to extract name information, classification information, and identification information. The terminal updates its local state by adding or refreshing entries in a notification list displayed to the user. The terminal invokes a user interface component on the display apparatus to render the name information and classification information and to associate the identification information with a selectable link or control. The terminal outputs a visual presentation that allows the user to recognize newly stored objects and, upon user interaction, to request access to the corresponding objects via the electronic information storage service.

### Step 12:

The server optimizes processing policies based on monitored data and the generative AI model.

The server receives, as input, historical metadata including classification outcomes, user correction records, retrieval frequencies, and notification interaction metrics, all stored in the storage apparatus. The server aggregates these data into monitoring target records using statistical computations such as frequency counting, averaging, and distribution estimation.

The server encodes these monitoring target records as feature vectors and provides them as input to the generative AI model configured for policy generation. The model outputs processing policy information, including adjusted thresholds for classification confidence, updated mappings between classification information and storage regions, and revised conditions for transmitting notifications. The server parses the policy information and updates the configuration object accordingly, modifying generation rules and transmission conditions.

The server outputs an updated configuration object that will be used in subsequent iterations to improve accuracy, reduce unnecessary computation, and adapt processing behavior to actual usage patterns.

### Step 13:

The server or the terminal generates a prompt sentence and updates the control program.

The server or the terminal receives, as input, a requirement change or an optimization request provided by the user or derived from system monitoring. The server or the terminal constructs a prompt sentence that describes desired behavior of the server, including acquisition of electronic communication information, extraction and validation of attached information, interaction with the electronic information storage service, use of the generative AI model for classification and notification generation, and adaptation of processing policies.

The server transmits the prompt sentence to a generative AI model specialized in program synthesis. The model processes the prompt sentence and outputs a candidate control program in textual form. The server receives the program text, verifies that required interfaces and safety constraints are satisfied, and stores the control program in the storage apparatus. The server then replaces or extends the previously executed control program with the new version, thereby updating the processing logic without manual coding. The server outputs a confirmation log indicating successful update of the control program and the prompt sentence used to generate it.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented document management systems that ingest electronic messages and store attached files in network-based storage often suffer from several technical shortcomings. First, such systems typically rely on static, rule-based parsing of message headers and file names, which leads to inaccurate or incomplete generation of metadata and tags for the stored files. As a result, the system's internal data structures and indices do not reflect the true relationships among documents, and search performance and retrieval accuracy are degraded at scale. This deficiency manifests as an increased computational burden on search engines and higher latency for search queries, particularly when the volume of stored data grows over time.

Second, conventional systems generally lack an integrated, content-based duplicate detection mechanism that operates at the time of ingestion in coordination with a storage hierarchy. In many cases, the system merely stores each attachment as a separate object in a generic folder structure without computing robust identification values based on content features and metadata. This leads to redundant storage of semantically identical documents, inefficient use of storage resources, and degraded performance of indexing and backup processes.

Furthermore, the absence of coordinated duplicate control complicates the maintenance of consistent indices and weakens the reliability of search results.

Third, typical notification subsystems are implemented as simple event triggers that send fixed-format messages whenever new content is stored or updated. These subsystems usually do not integrate with indexing structures or metadata-rich representations of documents, and do not generate deep links that deterministically direct a user terminal to a specific view or filtered dataset. Consequently, notifications do not effectively guide user interfaces to the relevant data structures within the storage and indexing system, causing additional round-trip queries, unnecessary user interaction steps, and inefficient consumption of network and processing resources.

Fourth, existing architectures that introduce machine learning or generative models often treat such models as external advisory tools, rather than integrating them as first-class components that directly control metadata extraction, index generation, storage optimization, and notification behavior. As a result, system operators must manually adjust rules and parameters in response to changing data patterns and workloads, which leads to suboptimal configuration of data placement, index structures, and notification policies. This manual approach makes it difficult for the system to adapt to dynamic operational conditions, such as changes in document types, communication patterns, or system load, and therefore limits the scalability and robustness of the computer technology as a whole.

Accordingly, there is a need for an improved computer-implemented system that uses a processor and memory to: (i) automatically ingest and analyze electronic message data and associated file data, (ii) generate and maintain rich meta-information and search indices by using a generative AI model, (iii) perform content-based duplicate detection and storage organization in coordination with an information storage apparatus, and (iv) generate intelligent, context-aware notifications that are aligned with the indexing structures and that include deterministic navigation information for user terminals. There is also a need for the system to dynamically optimize data placement, index configuration, and notification conditions by using a generative AI model, thereby improving storage efficiency, search performance, and overall operation of the computer system.

The specific processing by the specific processing unit 290 of the data processing device 12 in Application Example 1 is realized by the following means.

The present invention provides a server comprising a processor and a memory storing instructions that, when executed by the processor, cause the processor to acquire message data from a message transfer apparatus by using a message access protocol, extract file data from the message data, determine a type and a format of the file data, input the extracted file data and the message data to a generative AI model executing apparatus, cause a generative AI model to generate meta-information including at least a document category, a date, and a counterpart entity identifier, generate tag information and storage hierarchy information on the basis of the meta-information, store the file data and the tag information in an information storage apparatus while configuring a storage structure on the basis of the storage hierarchy information and managing the meta-information in association with the stored file data, generate an identification value for the file data on the basis of at least one content feature of the file data and the meta-information, compare the identification value with an existing identification value in the information storage apparatus to detect duplicate file data, execute integration control or deletion control for the duplicate file data, generate search index information by using the meta-information stored in the information storage apparatus so as to enable extraction of a stored data set in response to a search condition including at least one of a document category, a time period, and a counterpart entity, generate, in a notification control apparatus and by using the generative AI model executing apparatus, notification content including a notification body, summary information, and reference information on the basis of storage or update of the file data in the information storage apparatus, allocate the notification content to a plurality of communication paths including at least an electronic message notification and a terminal-directed push notification, generate reference link information for specifying a transition destination of a display screen on a user terminal on the basis of the notification content and the search index information, transmit a notification including the reference link information via a communication interface, and receive control information including a prompt sentence and, in response to the control information, switch or adjust parameters of the generative AI model and update at least one of a meta-information extraction rule and a notification content generation rule. This enables a computer system to automatically organize and de-duplicate stored file data, maintain optimized search indices, and deliver context-aware notifications that directly correspond to the underlying storage and indexing structures, thereby improving storage efficiency, search responsiveness, and overall operation of the computer-implemented document management technology.

The term “message transfer apparatus” refers to a communication apparatus, such as a mail server or message relay server, that transmits, receives, stores, and forwards electronic message data using a message transfer protocol.

The term “message access protocol” refers to a communication protocol that allows a client or server to access, retrieve, and manage message data stored in a message transfer apparatus, and includes protocols such as an internet message access protocol and a post office access protocol.

The term “message data” refers to electronic data representing a message, including at least header information, body text, and one or more attached data portions encoded in a structured format.

The term “file data” refers to electronic data that is attached to or referenced by message data and that is treated as a discrete digital object, including at least document data, image data, or other binary content.

The term “type of the file data” refers to a classification category of file data based on content or usage, including, for example, a document category, an image category, or another functional category.

The term “format of the file data” refers to a representation scheme of file data defined by a file format specification, including, for example, a portable document format, an image format, or another standardized or proprietary format.

The term “generative AI model executing apparatus” refers to a computing apparatus, including at least a processor and a memory, that is configured to load, execute, and manage a generative AI model for processing input data and generating output data.

The term “generative AI model” refers to a machine learning model that has been trained on data to generate output data, such as text, metadata, or other structured or unstructured information, in response to input data including control information or a prompt sentence.

The term “meta-information” refers to information that describes attributes, properties, or relationships of file data or message data, including at least a document category, a date, a counterpart entity identifier, and other identification information.

The term “document category” refers to a classification label that indicates a kind of document, including, for example, a delivery-type document, a billing-type document, or another transaction-related document.

The term “date” refers to temporal information associated with file data or message data, including at least a calendar date encoded in a predetermined temporal format.

The term “counterpart entity identifier” refers to information that identifies an entity involved in a transaction or communication, including at least a name, an organizational identifier, or another unique or quasi-unique identifier of a counterpart party.

The term “identification information” refers to information that enables distinction of one piece of file data or message data from another, including a combination of categories, temporal data, entity identifiers, or other discriminative attributes.

The term “tag information” refers to one or more labels or key-value pairs that are associated with file data or meta-information and are used for classification, indexing, or retrieval in a storage or search system.

The term “storage hierarchy information” refers to information indicating a logical or physical placement structure for file data within an information storage apparatus, including at least a folder structure, a path structure, or a grouping structure.

The term “information storage apparatus” refers to a storage apparatus or storage service that stores and manages electronic data, including at least file data, meta-information, and tag information, and that provides read and write access through an interface.

The term “storage structure” refers to an internal organization of data within an information storage apparatus, including a hierarchy, a directory structure, a container structure, or another arrangement that determines how data is stored and accessed.

The term “identification value” refers to a computed value used to identify file data, including at least a hash value, a fingerprint, or another value derived from a content feature or meta-information of the file data.

The term “content feature” refers to a characteristic of file data that is derived from content of the file data, including at least a binary pattern, a textual pattern, a visual feature, or a statistical measure.

The term “duplicate file data” refers to file data that is determined to represent the same or substantially the same content as other file data, based on an identification value or a comparison of content features and meta-information.

The term “integration control” refers to processing that consolidates duplicate file data into a unified representation, including at least linking, merging, or designating a primary instance while updating references.

The term “deletion control” refers to processing that removes duplicate file data or redundant file data from an information storage apparatus in accordance with a predetermined rule.

The term “search index information” refers to structured information used to support retrieval operations, including one or more index entries that map search keys to stored data or meta-information.

The term “search condition” refers to one or more parameters used to specify a retrieval request, including at least a document category, a time period, a counterpart entity, or another attribute or combination of attributes.

The term “stored data set” refers to a collection of file data and associated meta-information that satisfies a specified search condition and is retrievable from an information storage apparatus.

The term “notification control apparatus” refers to a computing apparatus or functional unit that generates, manages, and transmits notification content to one or more terminals or recipients through a communication interface.

The term “notification content” refers to data that constitutes a notification, including at least a notification body, summary information, and reference information for accessing related file data or meta-information.

The term “notification body” refers to a main textual or structured part of a notification, including descriptive information about an event such as storage or update of file data.

The term “summary information” refers to condensed information that describes essential aspects of file data or an event, such as a document category, a date, and a counterpart entity identifier.

The term “reference information” refers to information that enables access to or identification of related file data or a related view, including at least an address, an identifier, or link information.

The term “electronic message notification” refers to a notification transmitted by an electronic message system, including at least an electronic mail system or another message delivery system.

The term “terminal-directed push notification” refers to a notification that is initiated by a server and delivered to a user terminal via a push-type communication service without a prior explicit pull request by the user terminal.

The term “user terminal” refers to an information processing terminal operated by a user, including at least a mobile terminal, a portable terminal, or a fixed terminal that can receive and display notification content.

The term “reference link information” refers to link information that specifies a transition destination within a user interface, including at least a uniform resource identifier or an internal navigation parameter for a user terminal.

The term “transition destination of a display screen” refers to a particular screen, view, or interface state in a user terminal that presents at least a portion of file data, meta-information, or search results.

The term “communication interface” refers to a hardware or software interface that enables data communication between a server and external apparatuses, including at least a network interface for packet-based communication.

The term “control information” refers to information used to control behavior of a generative AI model, including at least configuration parameters, instructions, and a prompt sentence.

The term “prompt sentence” refers to an input expression provided to a generative AI model that specifies a task, context, or desired output, and that guides the generation of meta-information or notification content.

The term “meta-information extraction rule” refers to a rule or parameter set used by a generative AI model or other processing logic to determine how to derive meta-information from message data or file data.

The term “notification content generation rule” refers to a rule or parameter set used by a generative AI model or other processing logic to determine a structure, style, or content of notification content generated from meta-information or system events.

The term “user state estimation apparatus” refers to an apparatus or functional unit that acquires and estimates a state of a user, including at least an emotional state, an attention state, or a workload state, based on sensor data or interaction data.

The term “user state information” refers to information representing an estimated state of a user obtained by the user state estimation apparatus.

The term “emotion analysis algorithm” refers to a computational procedure that analyzes user state information to estimate an emotional state or related affective attribute of a user.

The term “analysis result” refers to an output of the emotion analysis algorithm, indicating at least one attribute of a user's emotional or cognitive state.

The term “importance assignment of the meta-information” refers to weighting or prioritization applied to elements of meta-information, used for indexing, retrieval, or notification control.

The term “priority setting of notification” refers to assignment of a priority level to a notification, which influences at least an order, timing, or modality of delivery.

The term “monitoring result” refers to information obtained by monitoring stored data or search index information, including at least measured values or detected changes of operational indices.

The term “operational index” refers to a quantitative measure related to operation of the system, including at least storage usage, duplication degree, and search response time.

The term “optimization algorithm” refers to a computational procedure that determines configuration parameters or control policies by optimizing an objective function defined over one or more operational indices.

The term “data placement” refers to a manner in which data objects are arranged or distributed in an information storage apparatus, including at least the selection of storage locations or partitions.

The term “index configuration” refers to a structure and parameterization of a search index, including at least index fields, index segmentation, and update policies.

The term “notification condition” refers to a condition that defines when and how a notification is generated and transmitted, including at least a trigger rule, a recipient selection rule, or a content selection rule.

In one embodiment, a server implements the claimed system by executing a computer program stored in a non-transitory computer-readable medium. The server comprises at least one central processing unit (CPU), a main memory, a network interface, and a storage interface connected via a system bus. The server executes an operating system such as a general-purpose server operating system and runs application software modules implemented, for example, in a programming language such as Python or another high-level language. The server communicates with an external message transfer apparatus, an information storage apparatus, and one or more terminals over a packet-based communication network.

The server uses a message access protocol client library, such as an IMAP client library, to communicate with the message transfer apparatus. The message transfer apparatus stores message data including headers, body text, and file data encoded as attachments. The server uses a library such as an IMAP client module to authenticate to the message transfer apparatus and to download the raw message data. The server then uses an electronic message parsing library, such as an email parsing module, to convert the raw message bytes into structured message objects including header fields, body parts, and attachment parts.

The server implements a data processing module that operates on the structured message objects. The server extracts file data from attachment parts and determines a type and a format of each piece of file data. The server uses a content inspection library, such as a file type detection library, to detect a file format independently of a declared MIME type. The server thereby prevents misclassification of files and avoids storing incompatible data. The server further normalizes file names into a canonical pattern comprising temporal information, a counterpart entity identifier, and a document category so that the information storage apparatus can create a consistent storage hierarchy.

The server uses a generative AI model executing apparatus to perform metadata generation and notification content generation. In one embodiment, the generative AI model executing apparatus is implemented by the same physical server that runs the data processing module, and is realized as a dedicated process or container that loads and executes a neural network model. In another embodiment, the generative AI model executing apparatus is implemented as a separate computing node connected via an internal network, and communicates with the server via a remote procedure call interface or a REST interface.

The server loads a generative AI model that has been trained on text corpora including message subjects, body texts, file names, and associated ground-truth metadata. In one embodiment, the generative AI model is a transformer-based neural network comprising a plurality of self-attention layers, feed-forward layers, and layer normalization layers. The server stores model parameters in memory and uses a framework such as a tensor computation library to execute forward passes through the network. The server represents tokens from the message text and file name as embeddings and applies positional encodings.

The network outputs distributions over possible document categories, counterpart entities, and temporal expressions. The server uses a softmax function to convert logits to probabilities and selects one or more labels exceeding predetermined thresholds as metadata candidates.

The server optionally fine-tunes the generative AI model using supervised learning on domain-specific training data. The server uses a cross-entropy loss function for classification outputs and a token-level loss for generative outputs such as notification body text. During training, the server updates model weights using a gradient-based optimization algorithm, such as an adaptive moment estimation algorithm, based on backpropagated gradients. The server may apply data augmentation techniques such as random paraphrasing of subject lines, insertion of synthetic noise, and masking of entity names to improve robustness of metadata extraction. These training and fine-tuning procedures enable the server to handle noisy message inputs that would not be reliably processed by manual rules.

The server constructs explicit feature vectors from the message data and file data for auxiliary tasks such as duplicate detection. The server computes content features including cryptographic hash values of the binary file content, statistical features such as byte histograms, and, where applicable, textual features extracted from machine-readable portions of the file data using an optical character recognition engine or a document text extractor. The server stores these features in a structured data store, such as a relational database or a key-value store, and uses them to compute identification values for each piece of file data. The server compares identification values using exact match and approximate similarity metrics.

By computing cryptographic hashes, the server can detect exact duplicates with a single equality comparison in constant time. By computing higher-level features such as n-gram frequency vectors, the server can detect near-duplicates while still using efficient vector similarity methods.

The server uses the generative AI model executing apparatus to generate meta-information in a manner that differs from simple rule-based parsers. Instead of relying solely on deterministic patterns, the server encodes message text, file names, and contextual information into embeddings and passes them through the neural network, which has learned associations between textual cues and underlying semantic categories. For example, the model can infer that a message containing a term corresponding to a delivery document and a reference number should be labeled as a particular document category, even if the wording differs from predefined rules. This approach increases recall and precision of metadata extraction and reduces the number of misclassified documents, thereby improving the quality of search indices and the efficiency of retrieval operations.

The server stores file data, meta-information, and tag information in an information storage apparatus. The information storage apparatus can be implemented using a network-accessible object storage service, a distributed file system, or a database-backed document store. The server uses a storage application programming interface to upload binary file data and to associate metadata and tag information with stored objects. The server uses the storage hierarchy information generated by the generative AI model executing apparatus to determine folder paths, container identifiers, or key prefixes so that related documents are co-located in the storage layer. This arrangement reduces the number of storage access operations needed to retrieve related datasets and improves cache locality for commonly accessed categories.

The server also maintains a search index, implemented, for example, by a search engine or a dedicated indexing library. The server constructs index entries that map document categories, dates, counterpart entities, and other metadata fields to document identifiers and storage locations. The server periodically or incrementally updates the search index as new files are stored or existing files are modified. Because the metadata is generated with higher accuracy and consistency by the generative AI model, the resulting search index has lower redundancy and fewer erroneous entries. This directly reduces index size and improves search latency since fewer postings lists must be traversed for a given query.

The server implements a notification control apparatus as a software module that interacts with the generative AI model executing apparatus and the search index. When the server detects a storage event or an update event in the information storage apparatus, the server assembles contextual data including document identifiers, meta-information, and relevant user roles. The server constructs an input prompt sentence and sends it, together with structured metadata, to the generative AI model executing apparatus. The generative AI model receives the prompt sentence and structured fields and generates notification content comprising a human-readable notification body, summary information, and reference information. The notification body can include a concise description of the event, while the summary information includes key attributes such as document category, date, and counterpart entity. The server then transforms this generated content into structured notification messages for multiple communication paths, such as electronic message systems and push notification services.

For example, the server may use a prompt sentence such as:

“I want to develop an automated delivery note management system for a logistics center. The server should use IMAP to fetch incoming emails, automatically upload PDF and image attachments to cloud storage via a storage API, and generate tags such as ‘delivery note,’ date, and client name from the email content and file names. The system should also send email and push notifications to stakeholders when new documents are stored. Please explain in detail how to design the server-side architecture, including recommended libraries, data models for metadata, and methods for duplicate detection and efficient search.”

The server uses such a prompt sentence during system design or during adaptive configuration to obtain or refine rules, templates, or suggested architectures. In production, the server uses shorter prompt sentences that specify notification style, priority, and link formatting so that the generative AI model produces notifications optimized for the particular system configuration.

The server generates reference link information that encodes a deterministic navigation path into a user interface. The reference link information can include a uniform resource identifier specifying an endpoint on a web application, as well as query parameters that represent search conditions such as document category, time range, and counterpart entity. When a terminal receives a notification containing such reference link information and the user activates the link, the terminal opens a specific screen that immediately displays a subset of documents matching the underlying search condition. This avoids redundant search input by the user and reduces the number of network requests between the terminal and the server, thereby lowering communication load and improving responsiveness.

The terminal is implemented as an information processing device such as a smartphone, tablet, or personal computer. The terminal runs a web browser or a native application that sends search requests to the server and receives search results. The terminal uses the reference link information to call a server endpoint and to display the appropriate view. The terminal displays lists of documents, metadata fields, and, when user authorization permits, links to preview or download actual file data from the information storage apparatus. The terminal thereby acts as a thin client that relies on server-side indexing and metadata computation.

The user interacts with the system by sending electronic messages with file data attachments to an address associated with the message transfer apparatus and by operating the terminal to view notifications and to access stored documents. The user does not need to manually classify or tag attachments. The user can use simple search forms or activate links in notifications to retrieve relevant documents. However, the invention is not limited to user-centric workflows; the same technical structures can also support machine-to-machine interfaces where external systems generate messages and consume indexed data.

The server provides dynamic optimization capabilities that further improve computer performance characteristics. The server periodically monitors operational indices such as storage usage, duplicate rate, and search response time. The server sends summarized monitoring results to the generative AI model executing apparatus along with a prompt sentence that specifies an optimization goal. The generative AI model outputs candidate configuration changes, such as modifications to threshold values for duplicate detection, changes to index field weights, or reorganization of the storage hierarchy. The server evaluates these candidates, optionally using a reinforcement learning framework or a simulation environment, and applies selected changes to the data processing pipeline. Over time, this feedback loop enables the system to adapt to evolving data distributions and workload patterns more efficiently than static configuration.

Because the server computes content features, identification values, and search index entries using structured algorithms and neural network outputs, the system achieves technical effects that go beyond mere automation of human classification tasks. The server reduces the number of redundant objects stored in the information storage apparatus by detecting duplicates prior to long-term retention. This reduces storage capacity consumption and decreases the frequency and duration of backup and replication operations. The improved metadata accuracy and hierarchy alignment reduce index size and traversal cost, which improves search response times and reduces processor cycles consumed by query execution. The direct linkage between notifications and index entries reduces unnecessary user-driven searches, thereby lowering overall network traffic and server load.

In one alternative embodiment, the generative AI model executing apparatus uses a hybrid architecture combining a transformer network for textual inputs and a convolutional or vision transformer network for visual features extracted from image-based file data. In such an embodiment, the server feeds document images into a vision model that outputs class logits for document types and visual features that are fused with textual embeddings. A fusion layer combines these features before a final classification head and generative head. This architecture allows the server to accurately classify documents whose essential information is embedded in images rather than machine-readable text, thereby reducing classification errors that would otherwise arise from OCR failures.

In another alternative embodiment, the server uses a lightweight recurrent neural network or a smaller transformer model for on-premises installations with limited computational resources, while a cloud-based deployment uses a larger transformer model with more layers and parameters to achieve higher accuracy. The server selects an appropriate model profile based on resource constraints and desired latency, demonstrating that the architecture is adaptable while preserving the core data flow and technical effects described.

In still another embodiment, the server incorporates a rule-based post-processing layer that validates and adjusts the generative AI model outputs. For example, the server ensures that extracted dates fall within reasonable ranges and that counterpart entity identifiers match entries in a master entity registry. This hybrid approach leverages the generative AI model for flexible pattern recognition while using deterministic checks to enforce system-level consistency. This reduces the probability of corrupted or inconsistent metadata, which directly contributes to robust index maintenance and query reliability.

The server also maintains versioned configurations for the generative AI model and associated rules. Each configuration includes model parameters, threshold values, prompt templates, and index mapping definitions. The server tags stored metadata with the configuration version used at the time of ingestion. If system operators detect systematic classification errors, the server can roll back or adjust configurations and re-index affected documents. Because configuration versions are tracked at a fine granularity, re-indexing can be performed selectively, which reduces computational cost and avoids service disruption. Through these hardware and software arrangements, the server, terminal, and user cooperate in a system that uses generative AI models not merely as advisory tools but as integral components of the storage, indexing, and notification subsystems. The generative AI model is constrained and guided by explicit data structures, feature computations, and optimization loops, resulting in measurable improvements in storage efficiency, search accuracy, and computational performance. The combination of neural network-based metadata extraction, content-based duplicate detection, hierarchy-aware storage placement, and index-linked notification generation provides a concrete improvement to computer technology, rather than an abstract automation of human workflow decisions.

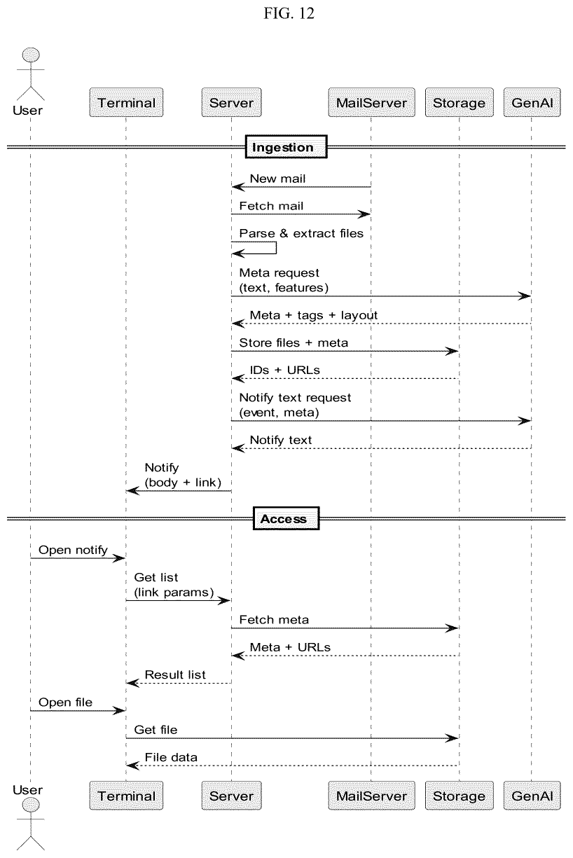

The following describes the processing flow using FIG. 12.

### Step 1:

The server connects to the message transfer apparatus and acquires raw message data.

The server receives, as input, configuration data including a host name, a port number, authentication credentials, and a target mailbox identifier, and the server uses a message access protocol (for example, IMAP) to establish a secure connection. The server transmits protocol commands to select a mailbox and to search for new or unread messages, and the server downloads raw message data as byte sequences. The server outputs a list of raw message objects, each containing header bytes, body bytes, and attachment bytes. The server thereby performs data acquisition and protocol-level parsing to convert network packets into structured raw message records in memory.

### Step 2:

The server parses the raw message data and extracts attachment file data.

The server receives, as input, the list of raw message objects from Step 1, and the server uses an email parsing library to decode the raw bytes into structured message structures. The server traverses each structure, identifies attachment parts by inspecting MIME headers, and decodes attachment payloads from transfer encodings into binary file data. The server records, for each attachment, a provisional file name, a declared MIME type, and basic properties such as size. The server outputs a collection of attachment records, each record including binary file data and associated message metadata such as sender, subject, and received date. The server thereby performs data structuring, converting unstructured message bytes into explicit attachment records.

### Step 3:

The server validates file types and normalizes file attributes.

The server receives, as input, the collection of attachment records from Step 2, and the server applies a file type detection routine that inspects magic numbers, header signatures, or byte patterns to determine an actual file format. The server compares a detected format with an allowed format list (for example, document formats and image formats) and discards or flags non-allowed formats. The server then normalizes file names by applying string operations that remove illegal characters, limit length, and embed metadata placeholders such as date tokens and counterpart entity tokens when available. The server outputs a filtered and normalized attachment list, where each attachment has a validated format and a canonical file name. The server thus performs data validation and attribute normalization based on pattern recognition and string transformation.

### Step 4:

The server prepares input features and sends them to the generative AI model executing apparatus.

The server receives, as input, the normalized attachment list from Step 3 and the structured message metadata from Step 2, and the server constructs feature representations for each attachment-message pair. The server tokenizes textual data such as subject lines, body snippets, and file names, and converts tokens into numerical indices. The server creates additional numerical features such as attachment size, file format code, and timestamp values, and the server packages these features into tensors or structured arrays. The server then transmits these feature packages, together with control information including a prompt sentence specifying the desired output fields (for example, document category, date, and counterpart entity), to the generative AI model executing apparatus through an internal interface. The server outputs a batched set of model input structures. The server thereby performs feature extraction and data formatting to prepare data for neural network inference.

### Step 5:

The server, via the generative AI model executing apparatus, generates meta-information and tag information.

The server receives, as input, the batched model input structures and the control information from Step 4, and the generative AI model executing apparatus loads a trained generative AI model into memory. The generative AI model applies multiple neural network layers such as embedding layers, self-attention layers, and feed-forward layers to the input tokens and features, and computes hidden representations that capture correlations between words, entities, and context. The server computes output logits for category labels, entity labels, and date expressions, and the server applies softmax or similar functions to obtain probability distributions. The server selects category labels and entity labels whose probabilities exceed predetermined thresholds and decodes date expressions from generated token sequences. The server then composes meta-information objects that include a document category, a normalized date, a counterpart entity identifier, and other identification information. The server further derives tag information and storage hierarchy information by mapping the meta-information to standardized tag sets and folder path patterns. The server outputs meta-information objects, tag lists, and storage hierarchy descriptors. The server thus performs probabilistic classification and sequence generation to derive structured metadata from unstructured inputs.

### Step 6:

The server computes identification values and detects duplicate file data.

The server receives, as input, the binary file data and the meta-information objects from Step 5, and the server computes identification values for each file. The server calculates cryptographic hash values over the binary content to obtain exact-match identifiers, and the server may also compute auxiliary features such as text fingerprints or visual feature vectors for near-duplicate detection. The server stores or fetches existing identification values and associated metadata from a local database or cache, and the server compares the new identification values with existing values using equality checks and similarity measures. The server identifies potential duplicate file data when a hash match or a similarity score above a threshold is found. The server then determines, based on configuration rules and timestamps, whether to keep a new file, keep an existing file, or merge references. The server outputs a classification of each file as unique or duplicate and, for duplicates, a mapping to a primary file record. The server thereby performs data comparison and decision logic to eliminate redundant storage objects.

### Step 7:

The server stores file data and meta-information in the information storage apparatus.

The server receives, as input, the deduplicated file data, the meta-information objects, the tag information, the storage hierarchy information, and any duplicate mappings from Step 6. For unique files, the server selects or creates a storage location based on the storage hierarchy information, such as a directory path or container identifier, and the server transmits a storage request with the binary file data to the information storage apparatus via a storage interface.

The server receives storage identifiers such as object IDs or URLs, and the server writes meta-information, tag information, and identification values into a metadata store, associating them with the storage identifiers. For duplicate files, the server updates references and metadata entries so that they point to an existing storage identifier without creating new binary copies. The server outputs persistent records comprising storage identifiers, meta-information, and tag information. The server thus performs data placement and metadata registration that organize documents according to semantically meaningful structures.

### Step 8:

The server builds and updates search index information.

The server receives, as input, the persistent records from Step 7, and the server constructs index entries that map key fields such as document category, date, counterpart entity, and identification value to storage identifiers. The server transforms metadata into index tokens, applies normalization (for example, lowercasing and stemming), and inserts or updates entries in a search index structure stored in an indexing engine. The server may perform batch insertion to minimize disk seeks or apply incremental updates with write-ahead logging to maintain consistency. The server also records inverse mappings from storage identifiers to index keys. The server outputs an updated search index that can be queried by specifying one or more search conditions. The server thereby performs indexing operations that enable efficient retrieval of stored data sets.

### Step 9:

The server generates notification content using the generative AI model executing apparatus.

The server receives, as input, event information indicating that file data has been stored or updated in the information storage apparatus, along with the corresponding meta-information and storage identifiers from Step 7 and the index keys from Step 8. The server constructs structured prompts that describe the event context and a desired notification style, and embeds a prompt sentence that instructs the generative AI model to generate a concise, informative notification body and a summary. The server sends the prompt and the structured metadata to the generative AI model executing apparatus, which processes the inputs through its neural network layers and outputs text tokens representing a notification body and a condensed summary. The server then parses and formats the generated tokens into notification content including a notification body, summary information, and reference information that identifies relevant storage identifiers and index keys. The server outputs complete notification content objects. The server thus performs guided text generation based on structured events to produce human-readable messages aligned with underlying metadata.

### Step 10:

The server allocates notification content to communication paths and embeds reference link information.

The server receives, as input, the notification content objects from Step 9 and the search index information from Step 8, and the server constructs reference link information that encodes navigation parameters such as document identifiers and search filters. The server generates uniform resource identifiers or other link structures that point to API endpoints or web application routes capable of reconstructing filtered views. The server then selects communication paths (for example, electronic message notification and terminal-directed push notification) based on configuration rules, notification priority, and user preferences stored in a user profile store. The server embeds the reference link information into each notification payload in a format appropriate for the selected path. The server outputs formatted electronic messages and push notification payloads ready for transmission. The server thereby performs path selection and link encoding to align notifications with specific user interface entry points.

### Step 11:

The server transmits notifications and the terminal receives and displays them.

The server receives, as input, the formatted notification payloads from Step 10, and the server uses a communication interface such as an electronic mail transfer protocol client or a push notification service client to transmit notifications to intended recipients. The server logs transmission results and, if necessary, schedules retries in case of temporary communication failures. The terminal receives, as input, the delivered notifications, decodes the payloads, and displays a notification banner or message containing the notification body and summary information. The terminal also stores the reference link information in association with the notification. The server thereby completes end-to-end delivery, and the terminal performs display rendering and link preservation.

### Step 12:

The user or the terminal activates reference link information and retrieves relevant data.

The user receives, as input, a displayed notification on the terminal and performs an operation such as tapping or clicking on the notification. The terminal interprets this operation as a request to follow the reference link information, constructs an access request to the server that includes encoded document identifiers and search conditions, and transmits the access request over the network. The server receives, as input, the access request, decodes the reference link information, and queries the search index from Step 8 using the specified conditions. The server fetches matching storage identifiers and meta-information from the metadata store, and returns a response containing a list of relevant documents and associated metadata. The terminal receives, as output, the response and renders a user interface that directly displays the filtered set of documents without requiring the user to re-enter search parameters. The server and terminal thus cooperate to execute index-based retrieval guided by notification-embedded navigation data.

### Step 13:

The server performs operational monitoring and optimization based on generative AI model suggestions.

The server receives, as input, operational data such as storage usage metrics, duplicate detection statistics, index size, and search response times collected during previous steps. The server aggregates these measurements into monitoring results and constructs a prompt sentence that specifies an optimization objective, such as reducing duplication rate or improving query latency. The server sends the monitoring results and the prompt sentence to the generative AI model executing apparatus, which outputs candidate parameter modifications, such as changes to thresholds for duplicate detection, adjustments to index field weights, or reconfiguration of storage hierarchy patterns. The server evaluates these candidates against stored policies and, when appropriate, updates internal configuration tables and processing parameters. The server outputs revised configuration values that influence subsequent executions of Steps 3 through 10. The server thereby performs a closed-loop optimization process, where learned suggestions from the generative AI model lead to concrete adjustments in data processing, storage, and notification behavior, resulting in measurable improvements in computation efficiency and system performance.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional information management systems that handle data stored in network-accessible storage devices and electronic message systems suffer from several technical deficiencies that limit scalability, responsiveness, and the efficient use of computing resources.

First, when visual information and record information such as image files, document files, and other binary objects are received via electronic messages or uploaded to a storage device, conventional systems typically require manually authored rules or fixed templates to classify, name, and describe such information. As a result, a processor must either leave many metadata fields empty or execute computationally expensive, hand-crafted parsing logic that does not adapt well to heterogeneous and evolving data formats. This leads to suboptimal indexing structures and increases the cost of subsequent retrieval, search, and access operations, thereby degrading overall system performance.

Second, in many existing architectures, the processor does not react to storage events in a unified, event-driven manner. Instead, periodic polling or ad hoc batch processes are used to detect new data in an information storage device. Such approaches introduce latency between the time data is stored and the time related processing is performed, cause unnecessary load on the storage and application servers, and make it difficult to maintain timely and consistent metadata. Furthermore, notification generation is often detached from the low-level storage layer, resulting in redundant transformations and increased complexity in the application stack.

Third, conventional notification mechanisms rely on static templates and fixed message formats that are configured at design time. The processor therefore lacks the ability to dynamically adapt notification content to different event types, user preferences, and evolving data structures. When a large volume of events must be communicated to multiple related-party terminals, such inflexibility causes either information overload (by sending verbose and redundant messages) or information loss (by omitting important contextual details). This adversely affects the usability of the system and increases the cognitive burden on users who must interpret low-level technical messages.

Fourth, many existing systems treat storage optimization, such as duplicate elimination, hierarchy restructuring, and storage resource allocation, as independent maintenance tasks that are decoupled from higher-level semantic information and event history. As a result, optimization routines often operate solely on raw file attributes such as size and timestamps, without leveraging richer context about how the information is used, how it was created, or how it is described to human users. This leads to suboptimal optimization decisions, inefficient use of storage resources, and poor transparency, because system administrators receive only low-level logs rather than human-readable, contextualized summaries.

Fifth, even when generative artificial intelligence models are employed, they are often used as isolated components without a structured integration of prompt sentences, event information, and user-configured templates. Without a systematic way of constructing prompt sentences that encode storage events, metadata, and user preferences, the processor cannot consistently obtain reliable and appropriately scoped outputs from a generative AI model.

This increases the risk of generating irrelevant or inconsistent notification messages and description texts, which in turn harms trust in the system and necessitates additional manual corrections.

Accordingly, there is a need for an improved computer-implemented system that (i) automatically reacts to storage events from an information storage device, (ii) integrates a generative information processing model in a structured, template-based manner via prompt sentences, (iii) performs adaptive information organization and optimization using both low-level storage state and higher-level semantic context, and (iv) automatically generates notification content and human-readable reports that are tailored to user-defined style constraints. Such a system should improve the technical functioning of the computer environment itself by reducing redundant operations, lowering latency between storage and notification, enhancing the structure and usability of stored information, and providing administrators with efficient, high-level visibility into optimization activities.

The specific processing by the specific processing unit 290 of the data processing device 12 in Example 2 is realized by the following means.

The present invention provides a server comprising a processor configured to analyze visual information and record information received via an electronic message interface, automatically store auxiliary information associated with such visual information and record information in an information storage device in response to event information generated by the information storage device, organize information stored in the information storage device by executing classification processing, association processing, and duplication determination processing, generate an input sentence by combining event information and user-configurable input sentence templates, input the input sentence to a generative information processing model to cause the generative information processing model to generate notification content including at least one of explanatory text, descriptive names, and descriptive documents, transmit the notification content to related-party terminals via a communication interface while storing record information related to transmission results, periodically acquire storage state information from the information storage device, execute optimization processing including duplicate information deletion processing, hierarchy structure reconfiguration processing, and storage resource allocation change processing based on the storage state information, and cause the generative information processing model to generate human-readable summary report text from processing history information of the optimization processing. This enables a computer-implemented environment in which storage events are processed in an event-driven and context-aware manner, metadata and notification content are generated and adapted dynamically through structured prompt sentences supplied to a generative AI model, storage resources are optimized using both low-level and semantic information, and users and administrators receive timely, human-readable notifications and reports that reduce manual intervention, improve system responsiveness, and enhance the overall efficiency and technical performance of the information management infrastructure.

The term “visual information” refers to any information that is primarily perceivable as images or graphics, including but not limited to still images, moving images, scanned documents, screenshots, and other image-based content represented in digital form.

The term “record information” refers to any information represented as structured or unstructured digital data, including but not limited to text documents, tabular data, log data, configuration data, binary files, and other machine-readable records.

The term “auxiliary information” refers to metadata or derivative information obtained from visual information or record information, including but not limited to extracted text, semantic labels, classification results, tags, summaries, and descriptive attributes associated with the original information.

The term “information storage device” refers to any hardware or software component, or combination thereof, that provides persistent or semi-persistent storage of digital information, including but not limited to network-accessible storage services, storage servers, file systems, and database systems.

The term “event information” refers to data indicating that an operation related to storage or retrieval has occurred in an information storage device, including but not limited to notifications of creation, modification, deletion, or movement of stored items and associated metadata such as timestamps, identifiers, and locations.

The term “storage target” refers to any unit of information that is subject to storage in an information storage device, including but not limited to files, objects, records, and data entries.

The term “information organization processing” refers to processing performed on information stored in an information storage device to improve its structure and accessibility, including but not limited to classification processing, association processing, and duplication determination processing.

The term “classification processing” refers to processing that assigns one or more categories, labels, or types to information based on its content, metadata, context, or other attributes, for purposes such as grouping, indexing, or filtering.

The term “association processing” refers to processing that establishes relationships among pieces of information, including but not limited to linking files to projects, relating documents to senders or recipients, and connecting records based on shared attributes or inferred semantic relationships.

The term “duplication determination processing” refers to processing that detects whether two or more items of information stored in an information storage device represent the same or substantially similar content, based on attributes such as hash values, sizes, timestamps, or content similarity metrics.

The term “input sentence” refers to a textual sequence, including one or more sentences or phrases, that is constructed for input into a generative information processing model in order to induce the generation of desired output, such as notification content or descriptive text.

The term “input sentence template” refers to a reusable textual pattern that includes fixed components and optionally variable placeholders, the pattern being used as a basis for constructing an input sentence by inserting event information, metadata, or other dynamic content.

The term “generative information processing model” refers to a computational model, typically implemented using machine learning or artificial intelligence techniques, that is configured to generate output information such as natural language text based on input information, including but not limited to generative AI models and large language models.

The term “notification content” refers to any information generated for the purpose of informing one or more recipients about an event or state related to stored information, including but not limited to explanatory text, descriptive names, descriptive documents, and links to stored items.

The term “explanatory text for notification” refers to a natural language text segment that describes an event, condition, or stored information in a manner suitable for being communicated to a human recipient as part of a notification.

The term “descriptive name for notification” refers to a human-readable name or title generated for a stored item or event, which is intended to succinctly indicate the nature, purpose, or content of the item or event when presented in a notification.

The term “descriptive document for notification” refers to a document or text body that provides a more detailed explanation or description of a stored item or event than an explanatory text or descriptive name, and that can be included in or referenced by a notification.

The term “related-party terminal” refers to any computing device operated by or associated with a person or process that is intended to receive notifications or reports, including but not limited to client computers, mobile terminals, and network-connected display devices.

The term “electrical communication path” refers to any communication medium or network infrastructure that transmits digital signals between the server and one or more related-party terminals, including but not limited to packet-switched networks, wired connections, and wireless connections.

The term “record information relating to a transmission result” refers to information indicating the outcome of transmitting notification content, including but not limited to timestamps, recipient identifiers, delivery statuses, response codes, and error information.

The term “storage state” refers to information indicating the current or historical condition of information stored in an information storage device, including but not limited to usage amounts, distribution across storage locations, access histories, and structural organization.

The term “optimization processing” refers to processing that modifies information stored in an information storage device or its organization for the purpose of improving efficiency, performance, reliability, or resource utilization.

The term “duplicate information deletion processing” refers to optimization processing that removes one or more redundant instances of information determined to be duplicates, while preserving at least one instance or otherwise maintaining logical access to the content.

The term “hierarchy structure reconfiguration processing” refers to optimization processing that changes a structural arrangement of stored information, including but not limited to rearranging directory structures, modifying object prefixes, and regrouping related items.

The term “storage resource allocation change processing” refers to optimization processing that alters how storage resources are assigned or used, including but not limited to migrating information between storage tiers, adjusting quotas, and reallocating storage capacity among different groups of information.

The term “processing history information” refers to information that records operations performed by the system, including but not limited to logs or traces of optimization processing, organization processing, notification transmission, and interactions with the generative information processing model.

The term “summary report text” refers to a natural language text generated to concisely describe one or more operations, states, or results, such as a summary of optimization processing, in a form suitable for human reading and understanding.

The term “writing style setting information” refers to information that specifies preferences or constraints related to the style of generated text, including but not limited to formality level, tone, sentence structure, and other stylistic characteristics.

The term “length setting information” refers to information that specifies preferences or constraints related to the length of generated text, including but not limited to limits on the number of characters, words, or sentences.

The term “vocabulary setting information” refers to information that specifies preferences or constraints related to the choice of words in generated text, including but not limited to domain-specific terminology, restricted words, and preferred expressions.

The term “control parameter for the generative information processing model” refers to a value or set of values that influences the behavior of the generative information processing model, including but not limited to parameters defining randomness, output length, response format, and other generation characteristics.

The term “user” refers to any human operator or administrator who interacts with the server or related-party terminals to configure, initiate, or review operations of the system, including but not limited to setting templates, style preferences, and notification policies.

In one embodiment, the invention is implemented by a server, one or more terminals, and at least one information storage device interconnected via a digital communication network. The server comprises at least one processor, a main memory, and non-volatile storage. The server executes a program that implements the functions described below. The terminals comprise user-operated computing devices such as personal computers, tablet devices, or mobile communication devices, each including a display, an input interface, and a network interface.

The server uses a network-accessible storage service as the information storage device. The server may use, as concrete examples, an object storage service compliant with a key-value object model, a distributed file system, or a database system. The server uses a mail transfer subsystem, such as a Simple Mail Transfer Protocol (SMTP) server, and a mail access subsystem, such as a Post Office Protocol (POP) or Internet Message Access Protocol (IMAP) server, in order to receive electronic messages that include visual information and record information.

The server executes application software implemented, for example, in a general-purpose programming language and running on an operating system. The server uses software libraries for network communication (for example, HTTP client libraries), for storage service access (for example, object storage software development kits), and for parsing electronic messages (for example, Multipurpose Internet Mail Extensions parsers). The server further uses a generative AI model, which is a generative information processing model implemented as a neural network and deployed either as a local model running on the server or as a remote model accessible through a programmatic application programming interface.

The terminal provides a user interface through which the user configures system behavior.

The terminal displays configuration screens that allow the user to define input sentence templates, writing style preferences, length constraints, and vocabulary constraints. The user inputs prompt sentences and configuration values through text fields and selection controls displayed on the terminal. The terminal transmits these configuration values to the server over the network.

The server stores the input sentence templates and configuration values in a configuration database. The configuration database may be implemented as a relational database system.

The server represents each input sentence template as a text string that can include placeholders, such as “{project_name}”, “{file_count}”, and “{storage_path}”, which the server replaces with event-specific values. The server associates each input sentence template with an information type or an event type.

The server receives electronic messages that contain attachments representing visual information and record information. The server connects to the mail access subsystem using IMAP or a mail-specific application programming interface and retrieves message headers and bodies. The server parses each message to extract attached files and message text. The server identifies visual information by detecting file formats that represent images, videos, or scanned documents, and identifies record information by detecting file formats that represent textual documents, spreadsheets, or other digital records.

The server analyzes the visual information and record information by applying preprocessing procedures. For visual information, the server may apply image decoding and, optionally, optical character recognition using an image analysis engine. For record information, the server may apply text extraction using a document parsing library. The server thereby derives auxiliary information such as extracted text, structural metadata, and semantic keywords. The server stores the original data and the auxiliary information in the information storage device, using a defined directory hierarchy or object key scheme.

The server registers metadata describing the stored information in a metadata database. The server stores, as metadata, identifiers for stored items, storage paths, timestamps, hash values, content types, and references to auxiliary information. The server uses this metadata for subsequent classification processing, association processing, and duplication determination processing. By maintaining structured metadata, the server enables efficient indexing and retrieval operations, which improves data access performance compared to unstructured storage.

The server monitors the information storage device by subscribing to events emitted by the storage service. The storage service transmits event information when new objects are created, modified, or deleted. The server receives this event information as structured data and parses the data to identify the affected storage items and operations. The server records each event in an event log stored in the metadata database. The event log entries include identifiers, event types, timestamps, and storage paths. The server thus maintains an event-driven architecture that avoids periodic polling for changes and thereby reduces unnecessary load on the storage service and the server.

The server organizes the information stored in the information storage device by executing information organization processing. The server performs classification processing by assigning categories or labels to stored items. The server may use rule-based classification that examines file types, storage paths, sender addresses, or keywords extracted from the auxiliary information. The server may also use a discriminative machine learning model that maps feature vectors derived from content and metadata to category labels. The feature vectors may include term frequency values, term frequency-inverse document frequency values, content length, and hash codes. The server stores category labels in the metadata database as tag values associated with each stored item.

The server performs association processing by establishing relationships among stored items.

The server uses identifiers, sender and recipient addresses, subject strings, project names, or temporal proximity to infer relationships. The server records associations as relationship entries that reference pairs or groups of items. These associations enable faster navigation and graph-based queries across related information, reducing query complexity at runtime.

The server executes duplication determination processing by computing hash values for stored items, such as cryptographic hash functions applied to content bytes, and by comparing hash values among multiple items. The server may also compare file sizes and metadata fields to reduce the number of pairwise comparisons. When the server detects items that share identical or highly similar hash values, the server marks these items as duplicates.

The server records duplication flags and linkages in the metadata database, thereby enabling the system to avoid redundant processing on duplicate items and to support downstream optimization processing.

The server periodically acquires storage state information from the information storage device. The storage state information may include total storage usage per directory or namespace, object counts, access frequencies, and distribution across physical or logical storage units. The server reads this information using storage service APIs. The server uses the storage state information together with the duplication flags, association data, and event logs to decide optimization actions.

The server executes optimization processing in which the server deletes redundant information identified as duplicates, restructures directory hierarchies or object key prefixes, and reallocates storage usage among different logical categories or storage tiers. For example, the server may move rarely accessed data to a lower-cost storage tier, or may group frequently accessed items together to improve cache locality in the storage service. By combining low-level metrics (such as size and access frequency) with semantic metadata (such as project tags and association graphs), the server takes optimization actions that result in improved input/output performance, reduced storage cost, and reduced latency in retrieval operations.

The server uses a generative AI model to generate notification content and summary report text. In one embodiment, the generative AI model is implemented as a transformer-based neural network comprising an embedding layer, multiple self-attention layers, feedforward layers, and an output projection layer. The server provides tokenized input sentences to the generative AI model. The server uses a tokenizer that converts characters or words into numerical token identifiers. The server encodes sequences of token identifiers and feeds them to the generative AI model. The generative AI model applies self-attention operations to compute context-sensitive representations, and then applies non-linear transformations to produce output token probabilities. The server decodes the output probabilities into natural language text sequences.

The server trains or fine-tunes the generative AI model using a corpus of training examples that include pairs of input sentences and desired output texts. The server uses a loss function such as cross-entropy between predicted token distributions and ground-truth tokens. The server updates the neural network weights using gradient-based optimization methods such as stochastic gradient descent or variants thereof. The server may perform data augmentation by perturbing input sentences, modifying word order, or adding synthetic noise to increase robustness. By performing training and fine-tuning, the server adapts the generative AI model to domain-specific terminology and notification patterns.

The server constructs input sentences, also referred to as prompt sentences, by combining templates and contextual data. The server retrieves an input sentence template that corresponds to the event type or information type. The server replaces placeholders in the template with actual values derived from event information and metadata. The server also considers user-defined writing style, length, and vocabulary settings. The server sets control parameters for the generative AI model, such as temperature, maximum token length, and output format constraints, based on the user settings. Thus, the server controls the behavior of the generative AI model systematically instead of invoking it with unstructured or ad hoc prompts.

The user may input concrete prompt sentences on the terminal. For example, the user may input the following prompt sentence to guide dataset-related notifications:

“Create a short, polite notification for project members about the newly uploaded dataset, and include the project name and the storage path in the message.”

The user may input the following prompt sentence for document description:

“Summarize this email and generate a user-friendly file name and a two-sentence description for the attached document.”

The user may input the following prompt sentence for optimization reporting:

“Based on the following optimization log, generate a brief status report for system administrators, highlighting major deletions, archivals, and estimated storage savings.”

The terminal transmits these prompt sentences to the server. The server stores them as templates or uses them directly for constructing input sequences to the generative AI model.

By using such structured prompt sentences, the server enables predictable and controllable output generation.

The server generates notification content by inputting the constructed input sentences to the generative AI model. The server receives the output text and then post-processes the text to insert specific hyperlinks, identifiers, and timestamps. The server formats the notification content for each communication medium, such as email or chat messages. The server transmits the formatted content to related-party terminals using a mail-sending interface or message-oriented APIs. The server logs transmission results, including delivery status codes and timestamps, in the metadata database. This logging enables later analysis and error handling.

The server generates summary report text about optimization processing in a similar manner.

The server aggregates processing history information that includes executed optimization actions, affected file counts, storage savings, and timing. The server converts this history into a structured textual representation and uses it as part of an input sentence to the generative AI model. The server then receives a human-readable summary that explains the optimization actions in natural language. The server delivers this summary to administrator terminals as a status report.

The server thereby improves computer technology in multiple respects. First, the event-driven integration between the storage service and the generative AI model reduces latency from data arrival to notification and avoids unnecessary periodic scanning, which reduces processor and network load. Second, the server uses semantically rich metadata and association graphs to guide optimization processing, which results in more accurate identification of redundant data and more effective storage hierarchy restructuring. This improves overall storage utilization and reduces access time. Third, the server uses structured, configurable prompt sentences, template management, and explicit control parameters to systematically condition the generative AI model. This leads to more consistent and context-appropriate outputs compared to static templates or ad hoc string concatenation.

As a result, the server reduces the need for post-generation manual corrections, which reduces the number of cycles the processor must spend on handling exceptions.

In contrast to mere automation of human drafting, the server modifies internal data structures and execution flows in hardware and software to improve system-level qualities. The server maintains optimized indices, relationship graphs, and duplication maps in the metadata database, which directly impact query planning and access patterns. The server uses optimisation algorithms that exploit these structures to decide storage tiering and data movement operations. Consequently, the server reduces the number of input/output operations and network transfers required to serve future requests, thereby reducing physical resource usage. The server's use of the generative AI model is not limited to human-comprehension tasks; the server uses outputs to drive subsequent control decisions such as template selection and classification refinement, further improving computing performance.

The AI-based processing also follows rules and procedures that differ from conventional human operations. The server uses, for example, vectorized attention mechanisms and learned embeddings in the generative AI model, which allow the model to represent relationships between tokens and context much more densely than rule-based string handling.

The server leverages these internal representations to produce concise yet information-rich notification messages and descriptions that would be difficult to design manually with static rules. Because the server can adapt output length and vocabulary to user-specified constraints while preserving essential information, the server reduces noise in communication channels and minimizes the amount of data that must be transmitted over the network, which contributes to communication load reduction.

In other embodiments, the server may use alternative neural network architectures, such as recurrent neural networks or encoder-decoder architectures, or may use different optimization algorithms, such as adaptive gradient methods. The server may execute the generative AI model on dedicated hardware accelerators, such as graphics processing units or tensor processing units, to improve inference throughput. The server may integrate multiple generative AI models, for example one model for notification content and another for optimization reporting, and may select a model based on event type or performance requirements. The server may also deploy a local model for low-latency use cases and a remote model for complex generation tasks.

In still other embodiments, the server may modify the structure of the metadata database. The server may store metadata in a graph database to more efficiently represent associations, or may use an inverted index for keyword-based search. The server may apply additional algorithms, such as clustering or topic modeling, to group related documents and to further improve information organization. The server may adapt its optimization algorithms based on feedback from summary reports or user interventions, thereby implementing a closed feedback loop that gradually improves storage structure and system performance.

The terminal may be configured in various ways. The terminal may execute a dedicated client application or may use a browser-based interface rendered by the server. The terminal may also automate some user interactions, such as automatically generating default prompt sentences based on prior user behavior. The user can override or refine these prompts. The flexible terminal-side configuration enables the server to receive rich, fine-grained control parameters without changing the server's core program.

Through these embodiments and variations, the invention provides a concrete, technical implementation that leverages a generative AI model and structured prompt sentences to improve the functioning of a computer-based information management system, including improved storage organization, reduced processing and communication overhead, and enhanced quality and usability of system-generated messages and reports.

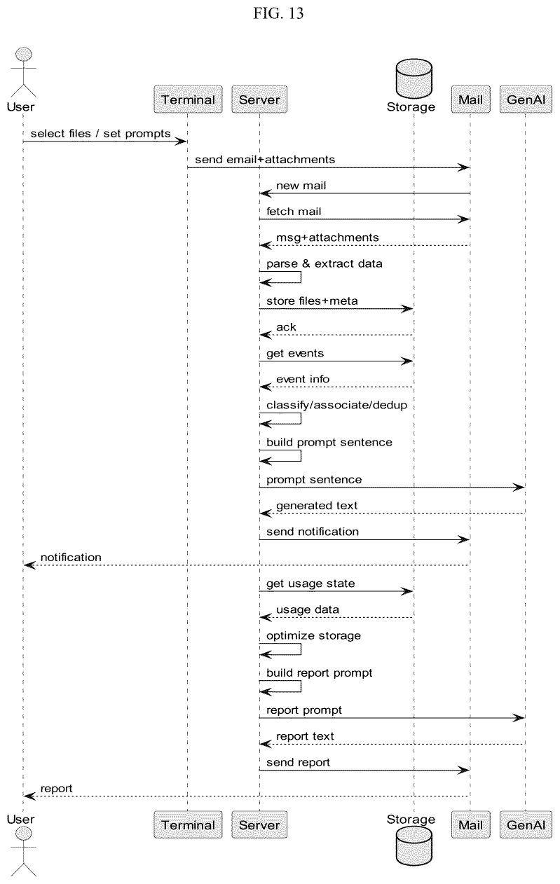

The following describes the processing flow using FIG. 13.

### Step 1:

The user selects one or more files on the terminal and initiates an upload or sends an electronic message with attachments.

The input is raw file data (for example, image files, document files, compressed archives) and message text entered by the user.

The terminal packages the selected files and message text into an upload request or an electronic message and transmits the data to the information storage device or to a mail server via a network interface using a communication protocol.

The output is a successfully transmitted data stream that is received and stored by the storage service or the mail server.

### Step 2:

The server acquires new electronic messages and attached files from the mail server.

The input is message headers, message bodies, and binary attachment data obtained from the mail access interface.

The server parses the message structure, decodes the attachments, and separates visual information and record information from the message text by applying a message parsing routine.

The output is a set of discrete data objects, each representing a single piece of visual information or record information, and an associated message text string.

### Step 3:

The server preprocesses visual information and record information to extract auxiliary information.

The input is the set of data objects and the message text obtained in Step 2.

The server applies image decoding and, if applicable, optical character recognition to visual information, and applies text extraction and format parsing to record information; the server thereby performs data transformations that convert binary content into character strings, structural metadata, and keyword lists.

The output is a structured representation that includes original data references, extracted text, structural metadata, and semantic keywords for each stored item.

### Step 4:

The server stores the original data and auxiliary information in the information storage device and registers metadata in a metadata database.

The input is the structured representation from Step 3 and storage configuration parameters.

The server assigns storage paths or object keys, writes the original data and auxiliary information to the information storage device using a storage service interface, and inserts or updates corresponding metadata records by computing identifiers, timestamps, and hash values.

The output is a set of persistent storage entries and associated metadata records that uniquely identify and describe each data item.

### Step 5:

The server receives and records event information from the information storage device indicating that new items have been stored.

The input is event notifications emitted by the storage service, including event type, object identifier, and timestamp.

The server parses the event payload, correlates the event with stored metadata records, and flags the corresponding entries as newly created by updating internal status fields in the metadata database.

The output is an updated event log and flagged metadata records that indicate which items require further processing.

### Step 6:

The server performs classification processing on stored information to assign categories and tags.

The input is metadata records, extracted text, and auxiliary information for the items flagged in Step 5.

The server computes feature vectors, such as term frequency values and content length, applies rule-based checks and, optionally, a discriminative classifier, and determines one or more category labels per item by evaluating decision criteria over these features.

The output is a set of updated metadata records in which each item has associated category labels and tags that express its classification result.

### Step 7:

The server performs association processing to establish relationships among stored items.

The input is metadata records containing sender identifiers, subjects, timestamps, project identifiers, and classification tags.

The server compares these attributes across items, computes similarity measures based on shared attributes and temporal proximity, and generates association links by grouping items that satisfy predefined rules or similarity thresholds.

The output is a relationship structure, stored as association records in the metadata database, that specifies links between related items.

### Step 8:

The server performs duplication determination processing to detect redundant information.

The input is content hash values, file sizes, and selected metadata fields for stored items.

The server compares hash values and, when necessary, performs secondary comparisons on size and additional attributes, and then marks items as duplicates when equivalence or high similarity is detected according to defined criteria.

The output is a set of metadata updates in which each duplicate item is annotated with duplication flags and references to a canonical item.

### Step 9:

The server periodically acquires storage state information from the information storage device for optimization purposes.

The input is storage usage statistics, access logs, and tier information retrieved through storage service interfaces.

The server aggregates these metrics per directory, project, and category, computes totals and averages, and correlates the computed values with classification, association, and duplication information stored in the metadata database.

The output is a consolidated storage state profile that characterizes the distribution, usage, and redundancy of stored data.

### Step 10:

The server determines and executes optimization actions based on the storage state profile and metadata.

The input is the storage state profile from Step 9 and the duplication and association records from Steps 7 and 8.

The server applies optimization algorithms that select candidate items for deletion, archival, or relocation by evaluating thresholds on usage, redundancy, and relationships, and then performs data operations such as deleting duplicates, moving low-usage items to different storage tiers, and restructuring directory hierarchies.

The output is a modified storage layout with reduced redundancy, updated access paths, and new optimization history entries recorded in the metadata database.

### Step 11:

The user defines or modifies prompt sentences and style settings on the terminal for use by the generative AI model.

The input is user-entered prompt sentences and parameters specifying writing style, text length, and vocabulary preferences.

The terminal packages these values into configuration messages and transmits them to the server, where they are stored as input sentence templates and control parameters mapped to event types.

The output is a set of persisted configuration records that the server can reference when constructing input sentences for the generative AI model.

### Step 12:

The server constructs an input sentence for the generative AI model based on event information, metadata, and templates.

The input is event log entries from Step 5, metadata and auxiliary information from Steps 4-8, and configuration records from Step 11.

The server selects a matching input sentence template, replaces placeholders with concrete values (such as project names, file counts, and storage paths), and appends or formats additional context, thereby generating a composed prompt sentence string.

The output is a finalized prompt sentence that encodes both user preferences and event-specific data for generation.

### Step 13:

The server encodes the prompt sentence and invokes the generative AI model to generate notification content.

The input is the prompt sentence from Step 12 and model control parameters such as temperature and maximum token length.

The server tokenizes the prompt sentence into numerical identifiers, passes the token sequence and control parameters to the generative AI model, and receives a sequence of output tokens that it decodes into natural language text; this processing applies attention-based computations and learned weight matrices within the model to transform the encoded prompt into coherent output.

The output is a generated text segment that constitutes notification content, including explanatory text, descriptive names, or descriptive documents.

### Step 14:

The server formats and transmits the generated notification content to related-party terminals.

The input is the generated text from Step 13 and recipient information derived from configuration records and metadata.

The server embeds the text into message templates for different channels, attaches hyperlinks and identifiers, and sends the formatted messages via mail interfaces and messaging APIs, while recording delivery status codes and timestamps in the metadata database.

The output is a set of delivered messages at the related-party terminals and corresponding transmission result records stored on the server.

### Step 15:

The server generates summary report text regarding optimization processing using the generative AI model.

The input is optimization history entries from Step 10, including counts of deleted items, relocated items, and storage savings, along with a reporting-oriented prompt sentence.

The server constructs an input sentence that describes the optimization actions in structured form, encodes it, and provides it to the generative AI model, which produces a concise natural language summary; the server decodes and post-processes the text to ensure required metrics are included.

The output is a human-readable summary report text that explains optimization activities and quantitative effects.

### Step 16:

The server transmits the summary report text to administrator terminals and updates system configuration if feedback is received.

The input is the summary report text from Step 15 and a list of administrator recipients retrieved from configuration records.

The server sends the report through configured communication channels and monitors responses or configuration changes from administrators, then updates optimization thresholds or template parameters in the configuration database based on received feedback.

The output is a delivered report available on administrator terminals and, where applicable, adjusted system parameters that influence subsequent classification, optimization, and notification operations.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented information management systems that ingest electronic communications, such as electronic mail, suffer from several technical limitations at the level of core data processing and system control. In many existing systems, extraction, storage, and organization of digital information attached to communications are performed by static rule sets and pre-defined schemas. As the volume and heterogeneity of the digital information increase, these static mechanisms lead to inefficient use of memory and storage resources, redundant data structures, and degraded retrieval performance. In particular, conventional systems do not dynamically adapt file naming, classification, or explanatory metadata to the actual content, which causes fragmented indices and sub-optimal data layouts in storage apparatuses, thereby increasing access latency and processing overhead for subsequent queries and background maintenance tasks.

Further, notification mechanisms in conventional systems are typically driven by simple event triggers without semantic understanding of the stored content. As a result, notification generation often relies on templated messages that do not reflect the actual importance or context of the underlying digital information. This tends to increase the number and size of notifications transmitted over communication means, contributes to unnecessary consumption of network and processing resources, and complicates prioritization logic within the system scheduler.

Moreover, when duplicate or unnecessary digital information accumulates across a storage apparatus, conventional optimization processes are usually limited to low-level comparisons such as file size or binary hash. These approaches do not leverage higher-level semantic similarity of content. Consequently, data reduction and optimization are incomplete, leaving redundant, semantically-duplicated information in the storage structure, which negatively affects input/output performance, memory hierarchy utilization, and the efficiency of backup and replication operations.

In addition, existing systems typically treat user-related state, such as emotion or cognitive load, as an external consideration handled only at the user interface layer, if at all. They do not use such state information as a first-class control signal inside the processing pipeline.

Therefore, conventional architectures cannot dynamically adjust the internal ordering of data organization tasks, the priority of message dispatch, or the granularity of information presentation in response to changes in user emotional state. This lack of adaptive control leads to non-optimal utilization of computational resources: high-priority items may be delayed, low-priority items may be processed eagerly, and display rendering paths may perform unnecessary work rendering detailed content that is unlikely to be consumed by a stressed user.

Furthermore, in systems handling transaction information or inventory information, the generation of aggregate views and overviews is often implemented by bespoke business logic. Such logic is hard-coded into application modules and is not easily generalizable or maintainable. It usually does not exploit large-scale language models or generative mechanisms to derive aggregated explanations from both structured aggregates and unstructured summaries. As a result, constructing overview screens and detail screens requires multiple passes over underlying data and a large amount of developer-maintained formatting rules, which increases CPU load, code complexity, maintenance cost, and error risk.

Accordingly, there is a need for an improved computer-implemented system that: (i) uses a generative AI model not merely as a peripheral tool, but as an integrated inference engine for generating summaries, classifications, identification names, explanatory documents, and optimization decisions; (ii) structures processing around explicit prompt sentences that convert internal state into a form consumable by the generative AI model; (iii) semantically controls storage organization, notification generation, and optimization actions; and (iv) incorporates user emotional state as a control parameter for adjusting data organization, notification priority, and display logic. Such a system should improve the efficiency, scalability, and adaptability of the underlying computer infrastructure, by reducing superfluous storage operations, lowering network and CPU load for unnecessary notifications, and dynamically focusing processing on information that is both semantically important and contextually appropriate for the user.

The specific processing by the specific processing unit 290 of the data processing device 12 in Application Example 2 is realized by the following means.

The present invention provides a server comprising a processor and a storage apparatus, the processor being configured to receive electronic communications including digital information, to extract body information and additional information from the digital information, and to generate attribute information associated with the body information and the additional information; to generate, based on the body information and the attribute information, a prompt sentence for causing a generative AI model to generate at least one of a summary, a classification, an identification name, and an explanatory document, to input the prompt sentence and the body information into the generative AI model, and to obtain at least one of the summary, the classification, the identification name, and the explanatory document from the generative AI model; to store the additional information in a storage area within the storage apparatus in association with the obtained summary, classification, identification name, or explanatory document, and to organize digital information stored in the storage apparatus by applying a classification algorithm; to detect that new digital information has been stored in the storage apparatus or that the summary or the classification of the digital information has been updated, to generate a prompt sentence for causing the generative AI model to generate content of a notification to be transmitted to a related party in response to a detection result, to input the prompt sentence and at least one of the summary and the classification into the generative AI model to obtain notification content, and to transmit notification information including the notification content via a communication means; to extract a candidate of duplicate information or unnecessary information from overall digital information within the storage apparatus, to generate a prompt sentence including at least one of a summary and meta-information of the candidate information, to input the prompt sentence into the generative AI model to obtain determination information regarding retention or deletion of the candidate information, and to optimize the digital information in the storage apparatus based on the determination information; to acquire state information of a user and specify an emotional state of the user by using an emotion analysis function based on the state information, to generate a prompt sentence including at least a part of the emotional state, the summary, the classification, and the notification content, to input the prompt sentence into the generative AI model to obtain control information relating to at least one of importance of notifications, transmission timing, and display style, and to adjust at least one of an organization order of the digital information, a priority of the notification information, and display content of the notification information based on the control information; and to apply a data structure processing function to a set of digital information including transaction information or inventory information to generate aggregate information by time series or by attribute, to generate a prompt sentence including the aggregate information and individual summary information, to input the prompt sentence into the generative AI model to obtain at least one of a total value for a period, an extraction result of major items, and an overview explanation for a user, to generate an overview screen and a detail screen for displaying the transaction information or the inventory information based on an obtained result, and to provide at least one of the overview screen and the detail screen to a terminal. This enables the underlying computer system to semantically drive storage organization, notification generation, and data optimization through prompt-controlled interactions with a generative AI model, to reduce redundant and unnecessary data at the storage level based on content-aware decisions, to adapt internal processing priorities and user interface rendering to real-time user emotional state, and to generate aggregate and overview representations of transaction and inventory data in a manner that reduces custom procedural code and improves processing efficiency, thereby providing a technical improvement in computer resource utilization, system responsiveness, and scalability.

The term “electronic communication” refers to a message transmitted over a digital communication network, including but not limited to electronic mail, messaging service data, or other network-based messages that contain digital information in structured or unstructured form.

The term “digital information” refers to information represented in a machine-readable format, including at least one of text data, image data, audio data, video data, and structured record data, that can be processed, stored, and transmitted by an electronic apparatus.

The term “body information” refers to text or equivalent main content extracted from an electronic communication, including subject lines, message bodies, and other principal narrative portions, excluding attachments and explicit metadata.

The term “additional information” refers to information associated with an electronic communication other than body information, including but not limited to attached files, embedded binary objects, and structured or semi-structured payloads that accompany the body information.

The term “attribute information” refers to metadata associated with body information and additional information, including identifiers, timestamps, origin and destination information, content descriptors, inferred categories, and other properties used to characterize and manage digital information.

The term “storage apparatus” refers to a hardware and/or software storage subsystem, including at least one of a local storage device, a network-attached storage system, and a remote storage service, capable of persistently storing digital information and associated metadata.

The term “storage area” refers to a logical or physical region within a storage apparatus that is allocated for storing digital information, including directories, partitions, containers, buckets, or logical volumes.

The term “generative AI model” refers to a machine-learned inference model that receives an input including a prompt sentence and optionally additional context, and that outputs generated information such as natural language text, identifiers, classifications, or summaries based on probabilistic or neural network-based computation.

The term “prompt sentence” refers to a machine-readable instruction sequence, typically expressed in natural language or structured text, that specifies to a generative AI model a requested operation or output format, and that may include contextual data such as summaries, classifications, or metadata.

The term “summary” refers to a condensed representation of body information or additional information, generated to retain essential meaning while reducing length and complexity for subsequent processing or presentation.

The term “classification” refers to an assignment of one or more category labels or classes to digital information, determined by algorithmic processing or by a generative AI model, for the purpose of organizing, indexing, or routing such information.

The term “identification name” refers to a machine-readable or human-readable name generated or assigned to digital information, used to uniquely or distinctively identify and reference that digital information within a storage apparatus.

The term “explanatory document” refers to a text document or equivalent structured content that describes the content, purpose, or context of digital information, including but not limited to annotations, descriptions, or usage notes.

The term “classification algorithm” refers to a computational procedure that assigns digital information to one or more categories based on features derived from the information or associated metadata, and includes both rule-based and model-based methods.

The term “notification information” refers to a data structure representing a message to be delivered to one or more related parties, including at least notification content and destination information, and optionally priority and timing parameters.

The term “communication means” refers to a communication interface and associated protocols that enable the transmission of notification information or other data between the system and external entities over a wired or wireless network.

The term “duplicate information” refers to digital information that is identical or substantially similar in content to other digital information stored within a storage apparatus, as determined by binary comparison, metadata comparison, or semantic comparison.

The term “unnecessary information” refers to digital information that is determined, according to system rules or model-based evaluation, to be redundant, obsolete, or of insufficient relevance to justify continued storage.

The term “candidate information” refers to digital information selected as a potential instance of duplicate information or unnecessary information, subject to further evaluation by an optimization process or a generative AI model.

The term “meta-information” refers to descriptive data about digital information, including but not limited to file names, sizes, timestamps, checksums, content types, and previously generated summaries or classifications.

The term “determination information” refers to information output from a generative AI model or other decision logic that indicates whether candidate information is to be retained, deleted, archived, or otherwise processed.

The term “optimize” refers to performing one or more operations on digital information in a storage apparatus to improve resource utilization, retrieval performance, or data quality, including removal of duplicates, deletion of unnecessary information, or reorganization of data structures.

The term “state information of a user” refers to data indicative of a condition of a user, including but not limited to biometric signals, interaction patterns, sensor readings, and behavioral indicators collected from one or more terminals or sensors.

The term “emotional state” refers to an inferred psychological condition of a user, such as stress, anger, satisfaction, or relaxation, estimated from state information of the user by an emotion analysis function.

The term “emotion analysis function” refers to a computational function or module configured to process state information of a user, including signals from sensors or interaction data, to estimate an emotional state of the user.

The term “notification content” refers to the substantive portion of notification information, including generated text or symbols that describe an event, status, or digital information to be communicated to a related party.

The term “control information” refers to information generated by a generative AI model or other logic that specifies at least one of notification importance, transmission timing, display style, or processing order for digital information or notifications.

The term “organization order” refers to a sequence or prioritization in which digital information is arranged, processed, or updated within internal data structures of the system.

The term “priority of the notification information” refers to a parameter indicating the relative importance or urgency of a notification, used by the system to schedule or filter transmission and display of notifications.

The term “display content of the notification information” refers to the specific elements of a notification that are rendered to a user, including level of detail, formatting, and inclusion or omission of explanatory information.

The term “data structure processing function” refers to a computational function configured to perform operations on structured collections of digital information, such as aggregation, grouping, sorting, or indexing over time-series or attribute-based dimensions.

The term “transaction information” refers to digital information representing an exchange event, including parameters such as time, counterpart, amount, and type of transaction, which is suitable for storage in structured records.

The term “inventory information” refers to digital information representing a state or change of stock or items, including quantities, identifiers, locations, and timestamps, managed within a storage or logistics context.

The term “aggregate information” refers to information derived from a set of digital information by combining multiple records according to at least one criterion, such as time period, category, or attribute, to produce totals, averages, or grouped statistics.

The term “overview explanation” refers to a generated descriptive text or structured output that presents a high-level interpretation of aggregate information and associated summaries for human consumption.

The term “overview screen” refers to a graphical user interface view that presents aggregate information and associated overview explanations in a condensed form suitable for quick understanding.

The term “detail screen” refers to a graphical user interface view that presents detailed digital information, including individual records, extended summaries, and associated metadata, in a more granular form than an overview screen.

The term “terminal” refers to an electronic device operated by a user, including but not limited to a personal computer, a mobile device, or a head-mounted display device, that is configured to communicate with the server and to present overview screens and detail screens.

In one embodiment, a server includes a processor, a main memory, a nonvolatile storage apparatus, a network interface, and one or more hardware accelerators such as a graphics processing unit. The server executes an operating system and an application program that implements the functions described in the claims. A terminal controlled by a user includes an input/output interface, a display device, at least one sensor, and a communication interface, and is configured to communicate with the server via a communication network.

Server executes a program generated in advance in a high-level language. The program is stored on the storage apparatus and loaded into the main memory for execution by the processor. The program is modularized into at least the following functional modules: an electronic communication acquisition module, a parsing and attribute generation module, a storage control module, a generative AI interaction module, a classification and optimization module, an emotion analysis interface module, and a user interface generation module. Each module is implemented as software executed on the processor; in alternative embodiments, part of the functionality is implemented by firmware or by executable logic in the hardware accelerator.

Server uses the electronic communication acquisition module to connect to a mail transfer system or a messaging system via the network interface. Server uses standardized protocols, such as IMAP or POP for mail retrieval and HTTPS-based APIs for messaging retrieval, to download electronic communications containing digital information. Server writes raw communication data into the main memory and then into the storage apparatus. Server invokes the parsing and attribute generation module to decode the communication data according to an internet message format and a multipart structure.

Server applies syntactic parsing to each communication and separates body information and additional information. Server treats body information as text content and additional information as binary payloads such as image data, document files, or structured data files.

Server generates attribute information as a structured record including identifiers, timestamps, sender and recipient information, media types, and preliminary heuristics such as keyword counts and estimated categories. Server stores attribute information in a data structure such as a relational table stored in the storage apparatus, where each row is keyed by a message identifier and a file identifier.

Server uses the generative AI interaction module to generate and transmit a prompt sentence to a generative AI model. Server configures the generative AI model as a neural network-based language model stored either locally on the server hardware or remotely on another computing resource. In one embodiment, the generative AI model has a transformer architecture including an embedding layer, multiple self-attention layers, feed-forward layers, and a final projection layer. The model parameters are trained in advance using a language modeling objective minimizing a cross-entropy loss over token sequences. During inference, server freezes the model parameters and uses them only for forward propagation.

Server converts body information and attribute information into token sequences according to a text encoding scheme. Server constructs a prompt sentence that includes instructions and context. For example, server generates a prompt sentence such as:

“Please summarize the following email content and propose an appropriate file name and a short description.

Email content: ‘The meeting minutes are attached. The next meeting will be on Tuesday next week.’”

Server concatenates the prompt sentence with a representation of the body information and inputs the concatenated sequence to the generative AI model. The generative AI model outputs a sequence of tokens representing at least one of a summary, a classification, an identification name, and an explanatory document. The transformer architecture internally performs attention operations between the tokens of the prompt sentence and the tokens representing the body information, thereby enabling the model to condition its output on both the instructions and the content. Because server encodes attribute information into the prompt sentence as explicit key-value-style text, the generative AI model can exploit this structured context to generate metadata that is semantically consistent with both content and attributes.

Server post-processes the output sequence by decoding tokens into text strings. Server splits the output into segments corresponding to the summary, the classification label, the identification name, and the explanatory document, based on delimiters or conventions described in the prompt sentence. Server validates and normalizes the identification name by removing illegal characters for the underlying file system and applying a deterministic transformation such as converting whitespace to underscores and converting upper-case characters to a standardized case. Server then stores the additional information in a storage area of the storage apparatus using the normalized identification name as part of the storage path or file name, thereby improving locality and searchability at the file system level. Server uses the classification and optimization module to organize digital information. Server loads attribute information and AI-generated metadata into a memory-resident data structure, such as a table representation implemented by an in-memory columnar structure. Server applies a classification algorithm that uses both rule-based conditions and AI-generated classification labels. For example, server classifies digital information into categories such as “inventory documents,” “transaction records,” and “meeting materials” according to a decision tree that uses AI-proposed categories as primary features and fallback heuristics as secondary features. This hybrid approach allows server to maintain deterministic behavior while still benefiting from the semantic generalization ability of the generative AI model.

Server writes back classification results to the storage apparatus by updating the database.

Because server uses AI-generated identification names and explanatory documents that reflect content, later queries that filter by text or by category can be translated into efficient index-based queries at the database level. As a result, the amount of random access to the storage apparatus is reduced, and cache hit rates in main memory are improved.

Server detects events that trigger notification generation by monitoring insertions or updates in the database. Server uses either database triggers that write to a message queue or a monitoring process that polls for rows whose status fields indicate a recent change. When server detects that new digital information has been stored or that a summary or classification has been updated, server generates a new prompt sentence for notification generation. For example, server produces a prompt sentence such as:

“A new document has been stored. Based on the following summary and classification, please generate a brief notification message for stakeholders.

Summary: ‘This email contains inventory arrival information for item ID 12345.’

Classification: ‘inventory’”

Server supplies this prompt sentence and context to the generative AI model. The transformer model processes the tokens and outputs a notification content string. Because the notification content is generated as a function of the summary, the classification, and instruction tokens in the prompt sentence, the resulting text is semantically concise and suitable for transmission.

Server encapsulates this notification content into a notification information structure including destination addresses and priority flags and transmits the notification information via a communication means, such as an email protocol or a messaging service.

Server performs optimization of digital information stored in the storage apparatus using both deterministic algorithms and the generative AI model. Server computes hash values and fingerprints for all stored digital information and identifies groups of candidate information that share identical or similar fingerprints. Server then generates prompt sentences that contain summary and meta-information of each candidate, for example:

“Determine whether the following two documents are redundant versions of the same content.

Document A summary: ‘October inventory report for warehouse A.’

Document B summary: ‘Inventory status for warehouse A in October.’

Respond with ‘retain both’, ‘retain A only’, or ‘retain B only’ and explain briefly.”

Server transmits these prompt sentences to the generative AI model and receives determination information indicating whether to retain or delete each candidate. Server uses this determination information in combination with storage policies to delete unnecessary information, migrate rarely-used information to lower-cost tiers, and compact storage layouts.

This optimization reduces write amplification and read amplification in the storage apparatus, shortens seek times, and improves the throughput of background maintenance tasks such as backup and replication.

Terminal acquires state information of a user and provides it to the server. Terminal includes at least one sensor such as a camera, microphone, or biosignal detector. Terminal gathers sensor data while the user interacts with information displayed on the terminal. Terminal locally pre-processes raw signals by extracting facial landmarks, voice pitch, or heart rate metrics and compresses them into numeric feature vectors. Terminal encrypts feature vectors and transmits them to the server via the communication interface.

Server receives state information from the terminal and applies an emotion analysis function.

In one embodiment, server hosts a separate neural network classifier trained on labeled emotion data, where the classifier accepts feature vectors and outputs an emotional state label and a confidence score. The classifier may be a recurrent network, a convolutional network, or a transformer encoder trained by minimizing a categorical cross-entropy loss. The model uses features such as temporal changes in facial expression, voice intensity, or heart rate variability to infer whether the user is stressed, angry, relaxed, or satisfied.

Server uses the resulting emotional state and confidence as additional context for generating control information through the generative AI model. Server creates a prompt sentence such as:

“The user is currently stressed. The following notifications are pending:
1) ‘New inventory has been added for item 12345.’
2) ‘Archived report has been updated.’

Please decide which notifications should be prioritized and how each notification message should be simplified.”

Server sends this prompt sentence and relevant summaries to the generative AI model.

Because the model receives explicit state information as part of the input tokens, it can produce control information specifying relative importance and suggested display styles.

Server translates this control information into internal scheduling parameters. For example, server assigns higher scheduling priority to notifications that the generative AI model designated as critical and delays or batches notifications that the model designated as non-critical.

Server also modifies display content for the user interface based on control information.

When the emotional state indicates stress, server instructs the user interface generation module to construct overview screens that omit secondary details and show only key numeric indicators or short sentences. When the emotional state indicates relaxation, server enables rendering of detail screens containing extended explanations, graphs, and document previews. Because server controls the complexity of the rendered views, the rendering pipeline in the terminal can avoid unnecessary queries and unnecessary layout computations when the user is unlikely to consume detailed information, thereby reducing processing load and improving responsiveness.

Server applies a data structure processing function to digital information that includes transaction information or inventory information. Server organizes records into time-series structures or attribute-sorted structures using in-memory frameworks that implement operations such as grouping, aggregation, and sorting. For each set of aggregated data, server constructs a prompt sentence such as:

“Summarize the following monthly transaction aggregates and highlight the major items for a user overview.

Aggregate data: ‘Total amount: 50,000 units. Online store: 20,000 units. Retail store: 5,000 units. Other categories: 25,000 units.’”

Server passes the prompt sentence and, where appropriate, individual summaries to the generative AI model. The model generates overview explanations that convert numeric aggregates into human-readable descriptions. Server uses these explanations, together with aggregate values, to construct overview screens. Server also links individual records and AI-generated summaries to detail screens. The use of the generative AI model in this context reduces the amount of hard-coded formatting logic required in the application. When new types of aggregates or new categories are introduced, server can adapt the textual explanations by adjusting prompt sentences without changing procedural code, which reduces error risk and maintenance overhead.

User operates the terminal to access overview screens and detail screens served by the server.

User may configure preferences such as which types of notifications to receive and what level of detail is desirable. Terminal transmits such preferences to server, and server combines them with emotion-derived control information and AI-generated control information to further refine the organization order and priority of notification information.

This configuration yields technical effects beyond mere automation of human tasks. By embedding prompt sentences that encode internal system state and constraints into the interaction with a transformer-based generative AI model, server achieves a tighter coupling between high-level semantics and low-level storage organization. This coupling allows server to generate metadata and decisions that optimize data layout, indexing, and caching behavior, thus improving throughput and latency of storage operations. The use of semantic duplicate detection and AI-assisted retention decisions reduces redundant writes and reads, improving input/output efficiency and mitigating wear on nonvolatile memory. The emotion-dependent dynamic adjustment of rendering complexity and notification scheduling reduces unnecessary processing on both server and terminal, lowers network traffic by avoiding the transmission of low-value notifications, and shortens perceived response time for high-priority events.

In alternative embodiments, server executes the generative AI model locally on a hardware accelerator using a quantized version of the transformer with reduced precision arithmetic.

This configuration reduces memory bandwidth and accelerates matrix multiplication operations, enabling faster generation of summaries and control information. In another embodiment, server offloads some inference requests to an external computing resource while caching frequent prompt templates and responses locally. This hybrid approach allows server to trade off latency and compute utilization while maintaining the same functional behavior.

In a further embodiment, terminal hosts a simplified version of the generative AI model that operates on-device for tasks such as local summarization of text before transmission.

Terminal generates local prompt sentences with truncated content and uses a compact transformer encoder-decoder network with fewer layers and reduced hidden dimensions. By performing partial summarization on the terminal, the system reduces the size of data transmitted to the server, thereby lowering communication load and improving privacy for sensitive content.

In another embodiment, server uses different generative AI models for different tasks. For example, a first model is specialized for classification and naming, trained with a loss function that emphasizes correct category and name generation, while a second model is specialized for notification phrasing and overview explanations. Server selects an appropriate model based on metadata fields and prompt sentence types. This modular architecture permits independent updates of model parameters and prompt templates for different subtasks, while preserving the overall data flow and technical advantages.

In yet another embodiment, server adjusts internal thresholds and parameters of the emotion analysis classifier based on feedback. When user corrects an emotion-based decision, terminal sends feedback to server, and server updates a calibration mapping that transforms classifier output scores into specific emotion states. Server then reflects this calibration in subsequent prompt sentences to the generative AI model. This feedback loop improves the precision of emotion-based control decisions over time and further reduces unnecessary or mistimed notifications.

Through these embodiments, server, terminal, and user cooperate to implement a system in which a generative AI model, controlled by explicitly constructed prompt sentences, is integrated into storage organization, notification generation, optimization, and user interface control in a manner that improves core computer performance, rather than merely substituting for human judgment.

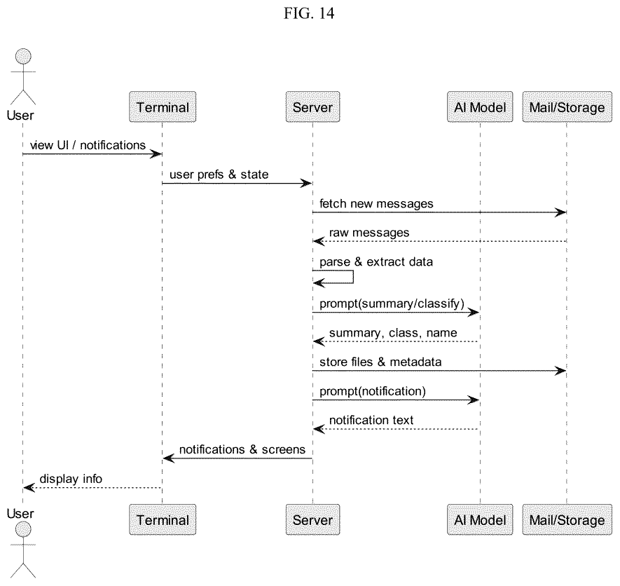

The following describes the processing flow using FIG. 14.

### Step 1:

Server acquires electronic communications.

Input: Raw messages from a mail system or messaging system (including headers, body, and attachments).

Output: Parsed body information, additional information, and preliminary metadata in memory.

Server connects to a mail transfer system using a protocol such as IMAP or POP and authenticates with stored credentials. Server issues commands to retrieve new messages and receives raw message data. Server decodes the message format, separates the header, body, and each MIME part, and identifies attachments as additional information (for example, image files or document files). Server normalizes the body information as plain text and generates preliminary metadata such as sender, recipient, subject, and reception time. Server stores this body information, additional information, and metadata in working data structures in main memory.

### Step 2:

Server generates attribute information.

Input: Parsed body information, additional information, and preliminary metadata.

Output: Attribute information records stored in a structured format.

Server analyzes body information using text processing (tokenization, keyword extraction, length calculation) and inspects additional information (file type, size, format). Server combines these analysis results with preliminary metadata to form attribute information, including identifiers, timestamps, content length, file types, and heuristic indicators such as suspected categories or importance scores. Server writes each attribute information record into a structured table in main memory and then persists it to a storage apparatus, associating each record with a message identifier and file identifier.

### Step 3:

Server constructs a prompt sentence for content analysis.

Input: Body information and associated attribute information.

Output: A prompt sentence prepared for a generative AI model.

Server reads the text of the body information and selected fields from the attribute information (for example, subject, keywords, and preliminary category). Server formats these into a single instruction text. For example, server generates a prompt sentence such as: “Please summarize the following email content and propose an appropriate file name and a short description.

Email content: ‘The meeting minutes are attached. The next meeting will be on Tuesday next week.’”

Server appends or embeds attribute values (such as approximate date and type indications) in a structured textual form. Server stores this prompt sentence as a string ready to be sent to a generative AI model.

### Step 4:

Server interacts with the generative AI model for summary, classification, and naming.

Input: Prompt sentence from Step 3 and body information text.

Output: Generated summary, classification label, identification name, and explanatory document text.

Server transmits the prompt sentence and body information to a generative AI model through an API call. Server converts the combined text to a token sequence and specifies inference parameters such as maximum output length. The generative AI model performs internal computation based on a transformer architecture and outputs a token sequence. Server decodes the token sequence to text and splits the text into separate segments corresponding to the summary, classification label, identification name, and explanatory document, according to delimiters or pattern markers described in the prompt sentence. Server stores these generated items in memory linked to the corresponding digital information.

### Step 5:

Server stores additional information using AI-generated metadata.

Input: Additional information files, AI-generated identification name, classification label, summary, and explanatory document.

Output: Files stored in a storage area with associated organized metadata.

Server normalizes the identification name by removing illegal characters and conforming to a file naming convention. Server constructs a storage path that incorporates the classification label or category (for example, “/inventory/2023/10/Meeting_Minutes_2023-10-10.pdf”).

Server writes the additional information file into the storage apparatus at the computed path.

Server updates a metadata table to associate the stored file path with the summary, classification label, identification name, explanatory document, and original message identifiers. This data processing ensures that subsequent lookups can be executed using both semantic criteria and structural indices.

### Step 6:

Server organizes stored digital information using a classification algorithm.

Input: Metadata table containing AI-generated classification labels and summaries.

Output: Organized index structures and updated category assignments.

Server loads relevant metadata records into an in-memory data structure. Server applies a classification algorithm that uses AI-generated classification labels as primary features and rule-based checks (for example, keyword presence or file type) as secondary features. Server updates each record's category field and builds or updates index structures (such as B-tree or hash indices) on category, date, and identification name fields. Server writes back these updates to the storage apparatus, improving future query performance and enabling efficient retrieval of related groups of digital information.

### Step 7:

Server detects changes that trigger notifications.

Input: Database state and recent write or update events for metadata records.

Output: A list of events indicating new or updated digital information to be notified.

Server monitors the metadata table by either processing events from database triggers or periodically querying for records whose status or timestamp fields indicate a recent insertion or update. Server filters these records to determine which changes require notification, such as newly stored inventory documents or updated transaction summaries. Server generates an event list containing identifiers, summaries, and classifications for each candidate notification event, and passes this list to a notification generation process.

### Step 8:

Server generates notification content using the generative AI model.

Input: Event list with summaries and classifications for each change.

Output: Notification content strings for each event.

Server constructs a prompt sentence for each event. For example, server generates a prompt such as:

“A new document has been stored. Based on the following summary and classification, please generate a brief notification message for stakeholders.

Summary: ‘This email contains inventory arrival information for item ID 12345.’

Classification: ‘inventory’”

Server sends the prompt sentence to the generative AI model and receives a generated notification content, such as “New inventory has been added for item 12345. Please review the attached arrival report.” Server records the notification content with the event identifier in preparation for transmission.

### Step 9:

Server transmits notifications via communication means.

Input: Notification content strings and recipient information.

Output: Notification information delivered to terminals.

Server composes notification information structures including recipients, channels (for example, email or messaging service), and the generated notification content. Server uses a communication protocol or messaging API to send notifications over the network. For email, server formats headers and body text and uses a mail sending protocol. For messaging services, server constructs API requests containing channel identifiers and message text.

Server records transmission results and updates the event list to mark notifications as dispatched.

### Step 10:

Terminal receives and displays notifications.

Input: Notification messages delivered via communication services.

Output: Displayed notifications on the terminal interface.

Terminal runs an email client or messaging client and receives incoming notifications.

Terminal parses received messages and extracts notification content. Terminal displays the notifications in a user interface area such as a notification bar or an application window.

Terminal may provide interactive controls allowing the user to open associated overview screens or detail screens served by the server.

### Step 11:

Terminal acquires state information of the user.

Input: Sensor data from the camera, microphone, or biometric sensors.

Output: Processed feature vectors representing user state information.

Terminal activates one or more sensors while the user interacts with displayed information.

Terminal captures images of the user's face, audio segments of the user's speech, or biometric signals such as heart rate. Terminal pre-processes these raw signals by detecting facial landmarks, computing spectral features for audio, and summarizing biometric time series. Terminal packages these features into compact numeric vectors and prepares them for secure transmission.

### Step 12:

Server estimates the emotional state of the user.

Input: Feature vectors representing user state information.

Output: Emotional state labels and confidence scores.

Server receives feature vectors from the terminal and feeds them into an emotion analysis function implemented by a neural network classifier. Server executes forward propagation through the classifier, which may include convolutional or recurrent layers specialized for temporal features, and obtains probability values for multiple emotion classes. Server selects an emotional state label (for example, “stressed” or “relaxed”) based on the highest probability and records the corresponding confidence score. Server stores the emotional state and score with a timestamp in an emotion log table.

### Step 13:

Server generates control information using the generative AI model based on emotional state.

Input: Emotional state, confidence score, candidate notifications, summaries, and classifications.

Output: Control information specifying notification importance, timing, and display style.

Server constructs a prompt sentence that embeds the emotional state and pending notifications. For example, server generates:

“The user is currently stressed. The following notifications are pending:
1) ‘New inventory has been added for item 12345.’
2) ‘Archived report has been updated.’

Please decide which notifications should be prioritized and how each notification message should be simplified.”

Server sends this prompt sentence and any relevant summaries to the generative AI model.

The model outputs control information indicating which notifications should be high priority, which should be delayed or batched, and what level of detail each message should contain.

Server parses this control information and stores it as structured control parameters associated with each pending notification.

### Step 14:

Server adjusts organization order and notification priority.

Input: Control information from Step 13 and queued notifications and data organization tasks.

Output: Updated scheduling order and priority for notifications and organization tasks.

Server updates internal scheduling queues used for processing notifications and for executing organization tasks. Server assigns higher priority to notifications designated as important and reduces or defers notifications marked as less important. Server similarly adjusts background organization operations, such as re-indexing or summarization tasks, by lowering their priority when the user is in a stressed state to avoid overwhelming the user with new information. Server writes updated priority values into queue data structures so that subsequent dispatch and processing obey the new ordering.

### Step 15:

Server generates optimized overview and detail screens for transaction and inventory information.

Input: Aggregated transaction or inventory data, individual summaries, and, optionally, emotional state and preferences.

Output: Data structures representing overview screens and detail screens.

Server applies aggregation functions to transaction or inventory records to compute totals per period, per category, and per item. Server constructs a prompt sentence that includes aggregate results and example summaries. For instance, server uses:

“Summarize the following monthly transaction aggregates and highlight the major items for a user overview.

Aggregate data: ‘Total amount: 50,000 units. Online store: 20,000 units. Retail store: 5,000 units. Other categories: 25,000 units.’”

Server sends the prompt sentence to the generative AI model and receives an overview explanation. Server then constructs overview screen data structures that combine numeric aggregates and the overview explanation. Server also generates detail screen data structures including per-record summaries, metadata, and links to stored files. If the emotional state indicates stress, server configures overview screens to show fewer details and hides some elements in detail screens; if the state indicates relaxation, server includes extended explanations and additional analytical views.

### Step 16:

Terminal renders overview and detail screens.

Input: Overview and detail screen data structures received from the server.

Output: Rendered visual interfaces displayed to the user.

Terminal requests and receives screen data from the server using an application protocol.

Terminal interprets the screen data, which specifies layout, text content, and interactive elements. Terminal renders an overview screen or a detail screen on the display. When the server has indicated a simplified style, terminal omits detailed sections and uses condensed layouts; when the server has indicated a detailed style, terminal renders full explanations, tables, and graphs. Terminal accepts user input such as clicks or taps and sends corresponding requests back to the server, enabling further navigation or data retrieval.

### Step 17:

Server performs optimization of stored digital information.

Input: Metadata and AI-generated summaries for all stored digital information.

Output: Updated storage state with reduced duplicates and reorganized content.

Server scans metadata records to identify groups of candidate duplicate or unnecessary information using hash values, sizes, and timestamps. For each group, server constructs a prompt sentence containing summaries and meta-information, for example:

“Determine whether the following two documents are redundant versions of the same content.

Document A summary: ‘October inventory report for warehouse A.’

Document B summary: ‘Inventory status for warehouse A in October.’

Respond with ‘retain both’, ‘retain A only’, or ‘retain B only’ and explain briefly.”

Server sends the prompt sentence to the generative AI model and receives determination information. Server then executes storage operations in the storage apparatus to delete or archive documents marked for removal and updates metadata entries accordingly. By doing so, server reduces storage consumption and improves data access performance.

### Step 18:

User interacts with notifications and screens.

Input: Rendered notifications, overview screens, and detail screens on the terminal.

Output: User actions and optional feedback transmitted to the server.

User reads notifications and decides whether to open associated screens or dismiss messages.

User navigates overview and detail screens to inspect transaction or inventory information.

User may explicitly indicate preferences such as “show more detail,” “fewer notifications,” or “mark this notification as low importance.” Terminal captures user actions and preference signals and sends them to the server. Server uses this input to adjust future prompt sentences, emotion thresholds, and control information generation, thereby refining behavior over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

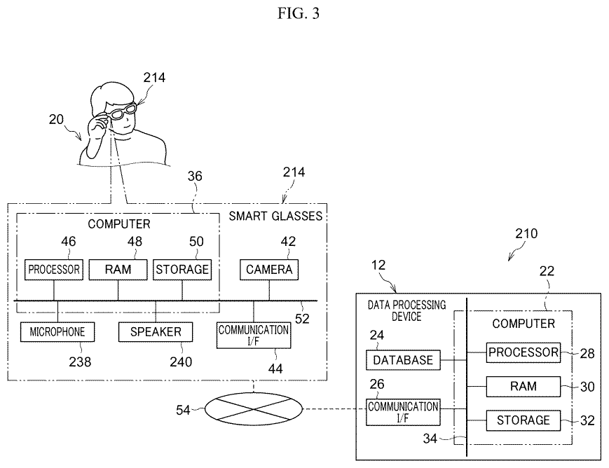

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

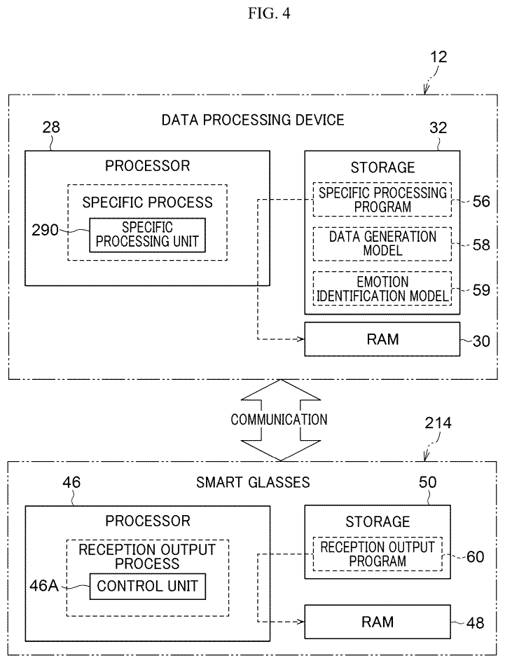

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

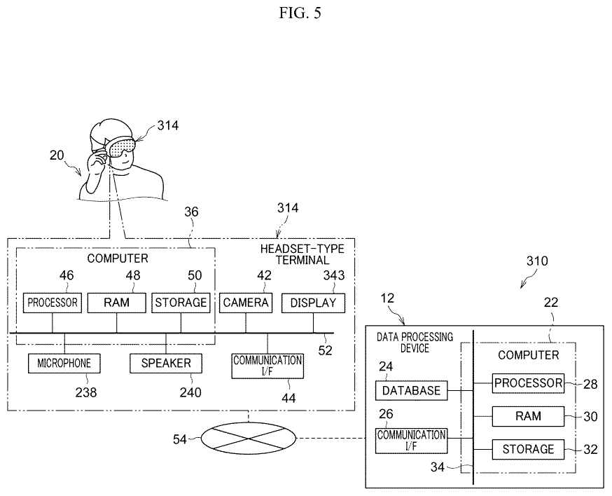

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

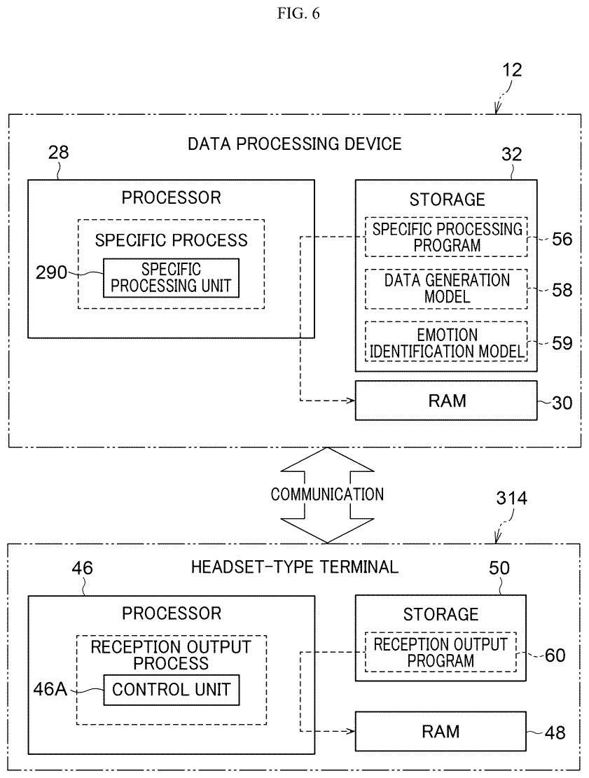

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

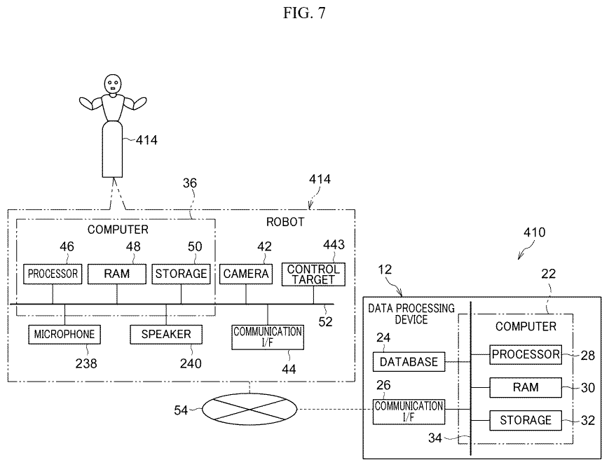

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

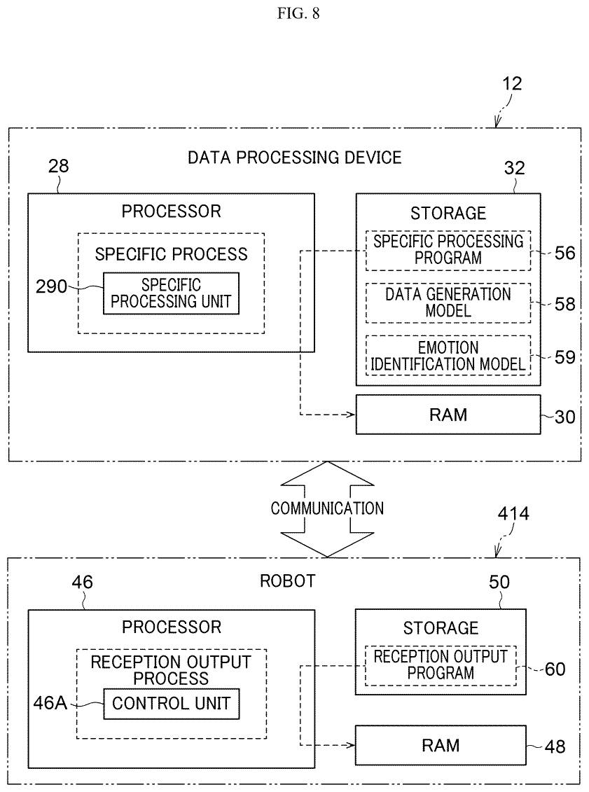

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

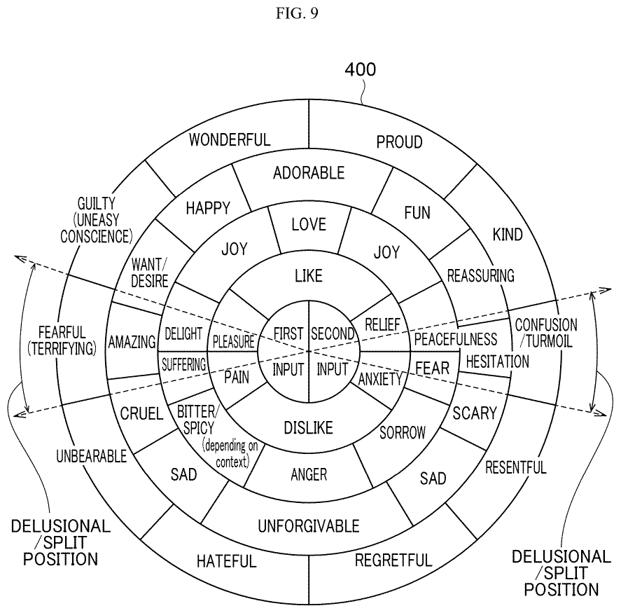

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

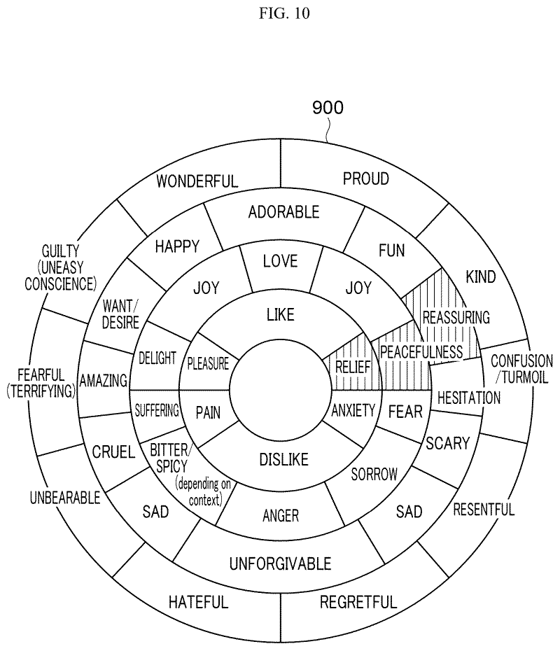

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a server, a storage apparatus, a communication apparatus, a display apparatus, and a processor,
wherein the processor is configured to cause the server to connect, via the communication apparatus and an electronic communication protocol, to an information processing apparatus and to acquire unprocessed electronic communication information from the information processing apparatus,
to cause the server to analyze structured information of the electronic communication information and to extract attached information represented as visual information or document information from the electronic communication information,
to cause the server to validate the attached information on a basis of type information and size information of the attached information and to select attached information that satisfies predetermined conditions,
to cause the server to store, by using a communication procedure provided by an electronic information storage service, the selected attached information in a storage region of the electronic information storage service as electronic information in the storage apparatus, and to acquire identification information associated with the attached information from the electronic information storage service,
to cause the server to generate name information of the attached information by normalizing the name information on a basis of subject information and time information included in the electronic communication information,
to cause the server to provide at least a part of the electronic communication information or at least a part of the attached information as input information to a generative AI model, and to cause a generation processing unit included in the generative AI model to generate classification information relating to the attached information, and to set the name information and the classification information as attribute information of the electronic information storage service with respect to the attached information,
to cause the server to provide input information including the name information, the classification information, and the identification information to the generation processing unit included in the generative AI model, and to cause the generation processing unit to generate notification information, and to transmit the notification information to a terminal via the communication apparatus, and
to cause the terminal to receive the notification information and to display, on the display apparatus, the name information, the classification information, and the identification information included in the notification information.

### (Supplementary 2)

The system according to supplementary 1,
wherein the processor is configured to cause the server to acquire content information of the electronic communication information and the attached information as monitoring targets, to provide the monitoring targets as input information to the generation processing unit included in the generative AI model, to cause the generation processing unit to generate processing policy information, and to dynamically change, on a basis of the processing policy information, at least a part of a generation rule of the name information, a generation rule of the classification information, or a transmission condition of the notification information so as to perform optimization.

### (Supplementary 3)

The system according to supplementary 1,
wherein the processor is configured to cause the server or the terminal to generate a prompt sentence representing program generation request information, to provide the prompt sentence to the generation processing unit included in the generative AI model, to cause the generation processing unit to generate a control program for executing processing of each function of the server defined in supplementary 1, and to store the control program in the server and to execute the control program in the server.

### Application Example 1

### (Supplementary 1)

A system comprising a processor,
wherein the processor is configured to
acquire message data from a message transfer apparatus by using a message access protocol, extract file data from the message data, and determine a type and a format of the file data, input the extracted file data and the message data to a generative AI model executing apparatus, and cause a generative AI model to generate meta-information including a document category, a date, a counterpart entity identifier, and other identification information, and generate tag information and storage hierarchy information on the basis of the meta-information,
store, in an information storage apparatus, the file data and the tag information received from the processor, configure a storage structure on the basis of the storage hierarchy information, and manage the meta-information in association with the stored file data,
generate an identification value for the file data to be stored on the basis of a content feature of the file data and the meta-information, compare the identification value with an existing identification value in the information storage apparatus, detect duplicate file data, and execute integration control or deletion control for the duplicate file data,
generate search index information by using the meta-information stored in the information storage apparatus, and extract a stored data set in response to a search condition including at least one of a document category, a time period, and a counterpart entity,
generate, in a notification control apparatus, notification content including a notification body, summary information, and reference information on the basis of storage or update of the file data in the information storage apparatus, by using the generative AI model executing apparatus, and allocate the notification content to a plurality of communication paths including electronic message notification and terminal-directed push notification,
generate, in the notification control apparatus, reference link information for specifying a transition destination of a display screen on a user terminal, on the basis of the notification content and the search index information, and transmit a notification including the reference link information via a communication interface, and
receive, in the generative AI model executing apparatus, control information including a prompt sentence from the processor, and in response to the control information, switch or adjust parameters of the generative AI model and update a meta-information extraction rule and a notification content generation rule.

### (Supplementary 2)

The system according to supplementary 1,
wherein the processor is configured to
receive user state information from a user state estimation apparatus, analyze the user state information by using an emotion analysis algorithm to obtain an analysis result, input the analysis result to the generative AI model executing apparatus, and dynamically change importance assignment of the meta-information and priority setting of notification performed by the notification control apparatus, in accordance with the analysis result.

### (Supplementary 3)

The system according to supplementary 1,
wherein the processor is configured to
monitor stored data and the search index information in the information storage apparatus periodically or in response to occurrence of a condition, input a monitoring result to the generative AI model executing apparatus, cause the generative AI model to generate or update an optimization algorithm that uses at least one operational index including storage usage, duplication degree, and search response time as an objective function, and
automatically optimize data placement, index configuration, and notification condition on the basis of the optimization algorithm.

### Example 2

### (Supplementary 1)

A system comprising a processor,
wherein the processor is configured to
analyze visual information and record information transmitted by electronic message, extract auxiliary information included in the visual information and the record information, and automatically store the auxiliary information in an information storage device, and
detect that a new storage target has been stored in the information storage device on the basis of event information transmitted from the information storage device, and
execute information organization processing, including classification processing, association processing, and duplication determination processing, for information stored in the information storage device, and
generate an input sentence for causing a generative information processing model to generate at least one of an explanatory text for notification, a descriptive name for notification, and a descriptive document for notification, on the basis of the event information and the information stored in the information storage device, and input the input sentence to the generative information processing model to cause the generative information processing model to generate notification content, and
transmit the notification content generated by the generative information processing model to related-party terminals via an electrical communication path, and store record information relating to a transmission result, and
store input sentence templates set by a user, select one of the input sentence templates in accordance with an information type or an event type, and generate the input sentence by combining the selected input sentence template with the event information, and
periodically acquire a storage state of the information stored in the information storage device, and execute optimization processing, including duplicate information deletion processing, hierarchy structure reconfiguration processing, and storage resource allocation change processing, on the basis of the storage state.

### (Supplementary 2)

The system according to supplementary 1,
wherein the processor is configured to
acquire setting information relating to a writing style, a length, and a vocabulary of the input sentence input by the user, and dynamically change the input sentence template for generating the notification content and a control parameter for the generative information processing model, on the basis of the setting information.

### (Supplementary 3)

The system according to supplementary 1,
wherein the processor is configured to
acquire the information stored in the information storage device and processing history information relating to the optimization processing, input the processing history information as the input sentence to the generative information processing model, cause the generative information processing model to generate a summarized report text for a human reader, and transmit the summarized report text to the related-party terminals.

### Application Example 2

### (Supplementary 1)

A system comprising a processor and a storage apparatus,
wherein the processor is configured to
receive electronic communications including digital information, extract body information and additional information from the digital information, and generate attribute information associated with the body information and the additional information; and
generate a prompt sentence for causing a generative AI model to generate at least one of a summary, a classification, an identification name, and an explanatory document based on the body information and the attribute information, input the prompt sentence and the body information into the generative AI model, and obtain at least one of the summary, the classification, the identification name, and the explanatory document from the generative AI model; and
store the additional information in a storage area within the storage apparatus in association with the obtained summary, classification, identification name, or explanatory document, and organize digital information stored in the storage apparatus by applying a classification algorithm; and
detect that new digital information has been stored in the storage apparatus or that the summary or the classification of the digital information has been updated, generate a prompt sentence for causing the generative AI model to generate content of a notification to be transmitted to a related party in response to the detection result, input the prompt sentence and at least one of the summary and the classification into the generative AI model to obtain notification content, and transmit notification information including the notification content via a communication means; and
extract a candidate of duplicate information or unnecessary information from overall digital information within the storage apparatus, generate a prompt sentence including at least one of a summary and meta-information of the candidate information, input the prompt sentence into the generative AI model to obtain determination information regarding retention or deletion of the candidate information, and optimize the digital information in the storage apparatus based on the determination information.

### (Supplementary 2)

The system according to supplementary 1,
wherein the processor is configured to
acquire state information of a user, specify an emotional state of the user by using an emotion analysis function based on the state information, generate a prompt sentence including at least a part of the emotional state, the summary, the classification, and the notification content, input the prompt sentence into the generative AI model to obtain control information relating to at least one of importance of notifications, transmission timing, and display style, and adjust at least one of an organization order of the digital information, a priority of the notification information, and display content of the notification information based on the control information.

### (Supplementary 3)

The system according to supplementary 1,
wherein the processor is configured to
apply a data structure processing function to a set of digital information including transaction information or inventory information to generate aggregate information by time series or by attribute, generate a prompt sentence including the aggregate information and individual summary information, input the prompt sentence into the generative AI model to obtain at least one of a total value for a period, an extraction result of major items, and an overview explanation for a user, generate an overview screen and a detail screen for displaying the transaction information or the inventory information based on an obtained result, and provide at least one of the overview screen and the detail screen to a terminal.

What is claimed is:

1. A system comprising:
circuitry configured to:
acquire, via a communication apparatus connected to an information processing apparatus using an electronic communication protocol, electronic communication information including structured message data and attached information encoded in the electronic communication information;
parse structured information of the electronic communication information to extract the attached information as binary data, and validate the attached information based on type information and size information against predetermined conditions to generate a filtered attachment set;
store the filtered attachment set in a storage region of an electronic information storage service via a communication procedure and acquire identification information associated with each stored attachment from the electronic information storage service, and generate name information by normalizing subject information and time information included in the electronic communication information;
provide at least a portion of the electronic communication information and the attached information as input to a generative neural network model to cause the generative neural network model to generate classification information relating to the attached information, and set the name information and the classification information as attribute information of the electronic information storage service with respect to the stored attachment;
generate an identification value for the attached information based on at least one content feature of the attached information and the classification information, compare the identification value with existing identification values in the electronic information storage service to detect duplicate attached information, and execute integration control or deletion control for detected duplicate attached information;
generate search index information using the classification information stored in the electronic information storage service to enable retrieval of stored data sets in response to search conditions; and
generate a prompt sentence by combining event information generated by the electronic information storage service with input sentence templates, input the prompt sentence to the generative neural network model to generate notification content including at least explanatory text and reference information, and transmit the notification content to a terminal device via a communication interface.

2. The system according to claim 1, wherein the circuitry is configured to generate tag information and storage hierarchy information based on the classification information, and store the attached information in the electronic information storage service with a hierarchical storage structure configured according to the storage hierarchy information.

3. The system according to claim 2, wherein the circuitry is configured to apply a message access protocol to connect to the information processing apparatus, issue protocol commands to retrieve unprocessed electronic communication information identified by message identifiers not yet recorded as processed, and update a processing record upon successful completion of storage and notification steps.

4. The system according to claim 3, wherein the circuitry is configured to generate the identification value by computing a content-derived hash from the binary data of the attached information and combining the hash with the classification information, and compare the identification value against a duplicate detection index in the electronic information storage service.

5. The system according to claim 4, wherein the circuitry is configured to generate meta-information including at least a document category, a date, and a counterpart entity identifier from the attached information using the generative neural network model, and use the meta-information to generate the tag information and the storage hierarchy information.

6. The system according to claim 1, wherein the circuitry is configured to periodically acquire storage state information from the electronic information storage service, execute optimization processing including duplicate information deletion processing, hierarchy structure reconfiguration processing, and storage resource allocation change processing based on the storage state information.

7. The system according to claim 6, wherein the circuitry is configured to cause the generative neural network model to generate a human-readable summary report from processing history information of the optimization processing, and transmit the summary report to a terminal device via the communication interface.

8. The system according to claim 7, wherein the circuitry is configured to apply emotion analysis processing to the electronic communication information to estimate an emotional state of a user, and adjust at least one of a storage organization priority and a notification transmission priority based on the estimated emotional state.

9. The system according to claim 8, wherein the circuitry is configured to select an input sentence template from among a plurality of user-configurable input sentence templates based on the estimated emotional state, and construct the prompt sentence by combining the selected template with the event information.

10. The system according to claim 1, wherein the circuitry is configured to generate the search index information by applying the classification information to a search indexing function, and enable extraction of stored data sets in response to search conditions including at least one of a document category, a time period, and a counterpart entity identifier.

11. The system according to claim 10, wherein the circuitry is configured to generate notification content including a notification body, summary information, and reference information based on storage or update of attached information in the electronic information storage service, and adjust a notification timing or transmission destination based on the classification information.

12. The system according to claim 11, wherein the circuitry is configured to store record information related to transmission results of the notification content in the electronic information storage service indexed by session identifier, message identifier, and timestamp.

13. The system according to claim 1, wherein the circuitry is configured to validate the attached information by comparing the type information and size information of each attachment against allowed types and permissible size ranges specified in a configuration object, and record rejection reasons in metadata fields for attachments that do not satisfy the predetermined conditions.

14. The system according to claim 13, wherein the circuitry is configured to apply string operations including character filtering, case normalization, replacement of prohibited characters, and time formatting to the subject information and time information to generate normalized name information, and append a sequence identifier when multiple attachments originate from the same electronic communication message.

15. The system according to claim 14, wherein the circuitry is configured to configure a hierarchical storage structure in the electronic information storage service based on the storage hierarchy information, and update the hierarchical storage structure when the classification information for an existing stored attachment changes.

16. The system according to claim 1, wherein the circuitry is configured to analyze visual information and record information received via the electronic communication protocol, automatically store auxiliary information associated with the visual information and record information in the electronic information storage service in response to event information, and organize information stored in the electronic information storage service by executing classification processing, association processing, and duplication determination processing.

17. The system according to claim 16, wherein the circuitry is configured to generate an input sentence by combining event information and user-configurable input sentence templates, input the input sentence to the generative neural network model to generate notification content including at least one of explanatory text, descriptive names, and descriptive documents, and transmit the notification content to related-party terminals via the communication interface.

18. A system comprising:
circuitry configured to:
acquire, via a communication apparatus connected to an information processing apparatus using an electronic communication protocol, electronic communication information and attached information extracted from the electronic communication information;
validate the attached information based on type information and size information against predetermined conditions, store valid attached information in an electronic information storage service, and acquire identification information for each stored attachment;
generate name information by normalizing subject information and time information from the electronic communication information, and provide the electronic communication information and attached information to a generative neural network model to generate classification information, and set the name information and the classification information as attribute information with respect to the stored attachment;
generate an identification value from at least one content feature of the attached information and the classification information, compare the identification value with existing identification values to detect duplicate attached information, and execute integration or deletion control for duplicates;
generate search index information using the classification information to enable retrieval of stored data sets; and
generate a prompt sentence combining event information from the electronic information storage service with input sentence templates, input the prompt sentence to the generative neural network model to generate notification content, and transmit the notification content to a terminal device via a communication interface.

19. The system according to claim 18, wherein the circuitry is configured to periodically acquire storage state information from the electronic information storage service, execute optimization processing including duplicate deletion, hierarchy structure reconfiguration, and storage resource allocation changes, and cause the generative neural network model to generate a summary report from optimization processing history.

20. A method comprising:
acquiring, via a communication apparatus connected to an information processing apparatus using an electronic communication protocol, electronic communication information including structured message data and attached information;
parsing structured information of the electronic communication information to extract the attached information as binary data, and validating the attached information based on type information and size information against predetermined conditions to generate a filtered attachment set;
storing the filtered attachment set in a storage region of an electronic information storage service and acquiring identification information associated with each stored attachment, and generating name information by normalizing subject information and time information from the electronic communication information;
providing at least a portion of the electronic communication information and the attached information as input to a generative neural network model to generate classification information, and setting the name information and the classification information as attribute information with respect to the stored attachment;
generating an identification value based on at least one content feature of the attached information and the classification information, comparing the identification value with existing identification values to detect duplicate attached information, and executing integration or deletion control for detected duplicates;
generating search index information using the classification information to enable retrieval of stored data sets; and
generating a prompt sentence by combining event information with input sentence templates, inputting the prompt sentence to the generative neural network model to generate notification content, and transmitting the notification content to a terminal device via a communication interface.
